(19) United States
(12) Patent Application Publication
(10) Pub. No.: US 2025/0182203 A1
(43) Pub. Date: Jun. 5, 2025

(54) MACHINE, APPARATUS AND METHOD SPECIFICALLY CONFIGURED FOR COMPUTING UNBIASED NON-PRICE-BASED INDEX WEIGHTS IN NON-PRICE-BASED INDEXATION OF SECURITIES

(71) Applicant: Peter Johansson, Greenwich, CT (US)

(72) Inventor: Peter Johansson, Greenwich, CT (US)

(21) Appl. No.: 18/527,329

(22) Filed: Dec. 3, 2023

(51) Int. Cl. G06Q 40/04

(52) U.S. Cl. CPC G06Q 40/04

(57) ABSTRACT

Embodiments of the present invention provide for a technical solution to systematic bias inherent in existing non-price-based securities indexation systems. Existing non-price-based securities indexing systems and methods either equal weight securities or base index weights on one or more fundamental size factors. These methods cause a bias towards stocks exhibiting low price-based index weights relative to size factor(s). As a result, existing non-price-based indexation methods determine index weights that are the exact opposite of how humans determine index weights in price-based indices. Embodiments of the present invention further provide for an improved securities indexation system, by improving efficiency, processing times, and memory requirements, in the process of determining unbiased non-price-based index weights in non-price-based indexation of securities.

### RELATED APPLICATIONS

This application is a Continuation-in-part of U.S. application Ser. No. 16/888,042, filed May 29, 2020, entitled “COMPUTER-IMPLEMENTED SYSTEM AND METHOD FOR NON-PRICE BASED INDEXATION IN AUTOMATED PASSIVE ASSET MANAGEMENT”, which is a Continuation of U.S. Application Ser. No. Ser. No. 16/221,374, filed Dec. 14, 2018, entitled “COMPUTER-IMPLEMENTED METHOD FOR PORTFOLIO CONSTRUCTION AND INDEXATION OF SECURITIES UNDER A NOISY MARKET HYPOTHESIS”, which is a Continuation of U.S. application Ser. No. 14/687,879, filed Apr. 15, 2015, entitled “COMPUTER-IMPLEMENTED METHOD FOR PORTFOLIO CONSTRUCTION AND INDEXATION OF SECURITIES UNDER A NOISY MARKET HYPOTHESIS”, which is a Continuation-in-part of U.S. application Ser. No. 11/957,703, filed Dec. 17, 2007, entitled “SYSTEM AND METHOD FOR DETERMINING PROFITABILITY OF STOCK INVESTMENTS”, which is a Non-Provisional of Provisional (35 USC 119(e)) of U.S. Application Ser. No. 60/871,676, filed Dec. 22, 2006, entitled “SYSTEM AND METHOD FOR DETERMINING PROFITABILITY OF STOCK INVESTMENTS” which is incorporated herein by reference in its entirety.

### TECHNICAL FIELD

Aspects of disclosed embodiments relate generally to securities indexation computer technology and more particularly to a particular machine, apparatus and method for automated non-price-based indexation of securities, processes, and techniques thereof. The technical field rely on a particular technical implementation (special purpose computer/particular machine) which is necessary for carrying out various processes (methods) in the field. It is understood that securities indexation is an existing technology.

### BACKGROUND

Price-based indexation of securities is the standard index weighting method in the indexing industry. Price-based indexes, such as the S&P 500, have historically provided a benchmark for the equity market. Since 1975 price-based indexes has also provided a tool for index-based funds (index fund or index trackers) which offers investors a cost-efficient alternative to active asset management. The problem with price-based indexation is that there is a human based assessment in determining price-based index weights. For that reason, price-based index weights may inherit human biases, which may lead to overstating index weights in some securities, industries and sectors and understating index weights others. To provide for a solution to this problem, the index industry has begun computing index weights based on non-price-based factors, such as fundamental factors, rather than on the price of securities.

However, the first generation of non-price-based indexes provide for yet another systematic bias, that is systematically overweighting relative to standard price-based indexes, securities, industries and sectors that exhibit a low price based index weight relative to fundamental size factors, such as earnings, book value and the like. As a consequence, the first-generation non-price-based indexes construction techniques does not determine index weights for individual securities in the same way as investors do in price-based indexes and as a result they exhibiting significant deviation relative to standard price based indexes. In fact, they exhibit the opposite weighting techniques. Such opposing techniques poses a problem for analysts, investors and policy makers, which may make analytical and policy judgments or investment decisions based on non-price-based index weights.

The present invention primary objective is to provide for a technical solution to systematic bias inherent in existing apparatuses and methods for determining non-price-based index weights in non-price-based indexation of securities.

### SUMMARY

The present invention's objective, as disclosed in various embodiments herein, is to improve upon existing technology, by providing for new processes (methods) that offers a solution to systematic biases inherent in existing processes for computing non-price-based index weights, and thus provide for a solution to systematic bias inherent in prior art processes.

It is appreciated that the overall objective of existing non-price-based index techniques is to provide for a solution to human bias inherent in standard price-based indexes. It is further appreciated that existing non-price-based-index processes generally compute index weights, either by the use of fundamental size factors, such as earning, book value, dividends and the like, or by equal weighting securities in an index. These methods or techniques determines higher non-price-based index weights, relative to standard price-based indexes, for securities that exhibit a low price relative to fundamental size factors, such earnings or book value. It is furthermore appreciated that investors in price-based indexes determine higher index weights for securities that exhibit a high price relative to fundamental size factors. As a result, standard price-based indexes and existing non-price-based indexes determine index weights in the exact opposite way, that is standard price-based indexes overweight's securities that exhibit a higher price relative to fundamental size factors (known as growth securities) and non-price-based indexes overweight securities that exhibit a low price relative to fundamental size factors.

This poses a problem for analysts and investors who want an unbiased assessment of equity markets. Hence, the objective with the present invention is to provide for a technical solution to the systematic bias inherent in existing non-price-based index techniques and where a new technique is desired that assign non-price-based index weights that exhibit reduced deviation or lower tracking error relative to standard price-based indexes.

According to some aspects, an improved non-priced-based weighting method is desired, that allows computing non-price-based index weights for individual securities that better correlate (agree or match up) to price-based-index weights in standard price-based-index benchmarks. As described in various embodiments herein, and of which is understood by the skilled in the art, non-price-based indexation of securities rests on an automated process, which requires a special purpose computer technology, a particular computer-based system, machines and apparatuses'. It is well understood that non-price-based indexation of securities is an existing technology.

In some embodiments, what is desired is a process, method or technique for weighting individual securities that overcomes systematic bias in existing non-price-based indexes. More particularly, in some embodiments, what is desired is a new non-price-based weighting method/process/technique that allows to control for systematic bias in existing non-price-based indexes, and thus allowing for computing unbiased non-price-based index weights for individual securities, industries and sectors.

According to one aspect, a special purpose computer comprises, at least one third party proprietary data base, at least one computer processor, and a non-transitory computer-readable storage medium containing instructions that, when executed by the at least one processor, causes the system to automatically perform operations, obtaining from at least one proprietary database, in real-time, non-price-based data updates for one or more securities, structuring and storing the obtained data in an internal database comprising one or more multidimensional arrays, determining, in real-time, unbiased non-price-based index weights using obtained data updates as structured and stored in at least one multidimensional array, for the one or more securities, computing unbiased non-price-based index weighs, for each one of the one or more securities, providing for a solution to systematics bias by computing a unit factor deviation rate and a discount rate, for the each one of the one or more securities, computing an unbiased non-price-based index weight for the each one of the one or more securities, by discounting obtained non-price based size factor data, by the discount rate for the each one of the one or more securities, and providing, in real-time, instructions based on the determined unbiased non-price-index-weights stored in the multidimensional array.

According to one embodiment the non-price data update for the each one of the one or more securities comprises a plurality of sub-factor updates, and computing the unit factor deviation rate comprises generating a composite factor from the plurality of sub-factor updates. According to one embodiment, computing the unit factor deviation rate comprises computing a factor change over a time interval and a factor deviation over the time interval using the factor data update for the each one of the one or more securities. According to one embodiment, computing the unit factor deviation rate over the time interval comprises computing a compound annual growth rate, a mean growth rate, a median growth rate, or a mode growth rate over the time interval.

According to one embodiment, computing the unit factor deviation rate comprises computing a plurality of factor changes for sub-intervals of the time interval, and computing the factor volatility as a standard deviation or a semi-deviation of the plurality of factor changes. According to one embodiment, computing the discount rate which further uses a risk-free rate. According to one embodiment, the discount rate does not depend on a share price of the each one of the one or more securities. According to one embodiment, computing the unbiased non-price index weight for the each one of the one or more securities comprises computing the non-price index weight as the greater of (i) the non-price-based size factor discounted by the discount rate, and (ii) using a book value for the each one of the one or more securities, wherein the book value, for the each one of the one or more securities, is obtained from a third-party proprietary data source.

According to one embodiment, computing the non-price index weight for the each one of the one or more securities comprises, computing the accumulated distribution for the each one of the one or more securities over a time interval using distribution information received from the third-party proprietary data source, and computing the unbiased non-price-based index weight as a sum of (i) the size factor value discounted by the discount rate, and (ii) the accumulated distribution value. According to one embodiment, the one or more securities includes two or more securities, and the operations further comprise transmitting instructions to a device to display the two or more securities in a graphical user interface in a descending order of computed unbiased non-price-based index weights.

According to one embodiment, the one or more securities includes two or more securities, and the operations further comprise transmitting instructions to a user device to display, providing instructions over the network to users to download via HTTPS and SFTP a multidimensional array comprising unbiased non-price-based index weights, for the two or more securities.

In some embodiments, distributions are added to both the computed non-price-based index weight and the contained book value in the process of computing the higher of (i.e., selecting the greater of; (i) the non-price-based size factor discounted by the discount rate, and (ii) the obtained a book value, for the each one of the one or more securities, wherein the book value, for the each one of the one or more securities, is obtained from a proprietary data source.

According to one aspect, a method of computing unbiased non-price-based index weights, comprising at least one computer processor is provided. The indexing system and method comprises obtaining, by the indexing system in real-time, non-price based size factor data updates for one or more securities from one or more proprietary data sources, determining, by the indexing system in real-time, unbiased non-price based index weights using the obtained non-price-based size factor data updates for the one or more securities, the non-price based computation, for each one of the one or more securities, comprises determining a factor change over a time interval and a factor volatility over the time interval using a factor data update for the each one of the one or more securities, determining a discount rate using the unit factor deviation rate and a risk free rate, computing a non-price based index weight for the each one of the one or more securities using the factor data update for the each one of the one or more securities, computing the non-price-based index weight for the each one of the one or more securities by discounting a obtained non-price-based size factor by the discount rate, and providing, by the indexing system in real-time, instructions based on the non-price based index weights to a securities indexing system to adjust an allocation of the one or more securities in the resulting unbiased non-price-based securities index.

According to one aspect, a non-transitory computer-readable storage medium containing instructions that, when executed by at least one processor cause the indexing system to automatically perform operations is provided. The system comprises obtaining, by the indexing system in real-time, data object updates for one or more securities from one or more proprietary data sources, computing, by the indexing system in real-time, unbiased non-price-based index weights using the obtained data object updates for the one or more securities, the non-price based computation, for each one of the one or more securities, comprising determining a factor change over a time interval and a factor volatility over the time interval using a factor data update for the each one of the one or more securities, wherein determining the factor volatility comprises, determining a plurality of factor changes for sub-intervals of the time interval, determining the factor volatility as a standard deviation or a semi deviation of the plurality of factor changes, determining a discount rate using the unit factor deviation rate and a risk free rate, computing a non-price based index weight for the each one of the one or more securities using the non-price-based size factor data update for the each one of the one or more securities, determining the unbiased non-price based index weight for the each one of the one or more securities by discounting an obtained non-price based size factor by the determined discount rate, providing, by the indexing system, instructions based on the computed non-price-based index weights to a financial services system to adjust an allocation of the one or more securities in the unbiased non-price-based securities index.

According to one aspect, a securities indexing system is provided. The system comprises at least one computer processor, and a non-transitory computer-readable storage medium containing instructions that, when executed by the at least one processor, cause the indexing system to automatically perform operations comprising obtaining, in real-time, factor data updates for one or more securities from one or more proprietary data sources, structuring and storing the obtained data in an multidimensional array, controlling for systematic bias by determining, in real-time, adjusted size factors using the obtained size factor data updates for the one or more securities, the adjusted size factor determination, for each one of the one or more securities, comprising computing a unit factor deviation rate using non-price-based size factor data updates for the each one of the one or more securities, computing an unbiased non-price-based index weight for the each one of the one or more securities using the size factor data updates, for the each one of the one or more securities, controlling for systematic bias by computing the adjusted size factor for the each one of the one or more securities by discounting the obtained size factor by a function of the unit factor volatility.

According to one embodiment the obtained size factor data update, for the each one of the one or more securities, comprises a plurality of sub-factor updates, and determining the non-price-based size factor comprises generating a composite size factor from the plurality of sub-factor updates. According to one embodiment, determining an adjusted size factor comprises averaging size factor values over a trailing period of time.

According to one embodiment, the method further comprises determining the instructions to adjust the allocation of the one or more securities in the index using the determined non-price-based index weights for the one or more securities in the index, and a constant factor selected to reduce concentration risk of the non-price-based securities index.

According to one embodiment, the operations further comprise computing a non-price-based index weight for the each one of the one or more securities using the non-price-based size factor for the each one of the one or more securities, a unit factor volatility and a risk-free rate, and determining the instructions to adjust the allocation of the one or more securities in the index using the computed non-price-based index weights for the one or more securities. According to one embodiment, computing the non-price-based index weight for the each one of the one or more securities comprises discounting the non-price-based size factor for the each one of the one or more securities by a unit factor volatility factor and the risk-free rate.

According to one embodiment, the one or more securities includes two or more securities, and the operations further comprises transmitting instructions to a user device to display the two or more securities in a graphical user interface in a descending order of computed unbiased non-price-based index weight.

According to one aspect, a method of non-price-based indexing performed by an indexing system comprising at least one computer processor is provided. The method comprises obtaining, by the securities indexing system in real-time, size factor data updates for one or more securities from one or more proprietary data sources, structuring and storing the obtained data in a multidimension array, in a particular way, allowing the indexing system to more efficiently determining, in real-time, adjusted size factors using the obtained non-price-based size factor data updates for the one or more securities, the adjusted size factor computation, for each one of the one or more securities, comprising computing a unit factor volatility using a factor data update for the each one of the one or more securities, computing a adjusted size factor for the each one of the one or more securities using the factor data update for the each one of the one or more securities, computing the non-price-based index weight for the each one of the one or more securities by discounting the obtained size factor by a function of the unit factor volatility.

According to one aspect, a non-transitory computer-readable storage medium containing instructions that, when executed by at least one processor, causes an indexing system to automatically perform operations is provided. The system comprises obtaining, by the indexing system in real-time, non-price-based factor data updates for one or more securities from one or more proprietary data sources, structuring and storing obtained data in an internal database comprising a multidirectional array in a particular way, determining, by the indexing system in real-time, adjusted size factors using the obtained non price based size factor data updates for the one or more securities, the adjusted size factor determination, for each one of the one or more securities, comprising determining a factor change over a time interval and a factor volatility over the time interval using the factor data update for the each one of the one or more securities, computing a unit factor volatility using the factor change and the factor volatility, determining an unbiased non-price based index weight for the each one of the one or more securities using the factor data update for the each one of the one or more securities, by discounting the obtained size factor by a function of the unit factor volatility.

The claimed embodiments primarily objective is to provide for a solution to systematic bias inherent in existing non-price-based indexing methods and systems. Some embodiments provide for alternative methods/techniques to meet this objective. Hence, claimed embodiments are primarily directed to providing for particular solutions to systematic biases in existing non-price-based indexes.

Some embodiments may be used as a new unbiased non-price-based index benchmark, i.e., used as a non-price-based alternative benchmark to conventional price-based index benchmarks. Some embodiments provide for a technical solution by the use of a particular process (particular methods/processes/techniques) of which in this application may be referred to as a “systematic bias control process, method, technique, tool, devise or unit” or “processing machine, apparatus, or processing control unit”, in computing unbiased non-price-based index weights in automated non-price-based indexation of securities.

A systematic bias control process may unitize a new and improved discount rate that controls for individual securities heterogeneous factor characteristics independent from the market price. These new processes (methods) allow for computing non-price-index weights that controls for heterogeneous factor characteristics, in a particular way, across individual securities in the process of determining unbiased non-price-based index weights for individual securities.

In some embodiments, the improved system and method for computing unbiased non-price-based index weights, progressively structure and store obtained and processed data in a multidimensional array, allowing the overall securities indexing system to reduce processing errors, reducing processing times and memory usage. The resulting unbiased non-price-based index benchmark provides for a particular useful alternative to conventional price-based index benchmarks (e.g., S&P 500) while improving over existing non-price-based indexes by providing for a technical solution to systematic bias in existing systems and methods.

In some embodiments, the computer-based systematic bias control process, implemented as part of an executable securities' indexing system, provides a technical solution to a problem in non-price-based indexation by providing for a solution to systematic bias in existing non-price-based systems and methods. It furthermore provides for a technical solution to a problem in index benchmarking, as it provides for more accurate (unbiased) estimates for non-price-based index weights for individual securities. This is particularly useful for policy makers, analysts and investors.

In addition to a conventional indexing system and methods, the embodiments as disclosed herein provide for improved system efficiency, as one or more embodiments, unitizes an internal database comprising a multidimensional array specifically configured to logically structure and store received (obtained) and processed data. The multidimensional array enables the system to perform more efficiently, by progressively and automatically structure and store obtained data and processed data in an unconventional manner, which efficiently aids the system and method to perform its desired tasks more accurately and more effectively.

In one embodiment of a system and method for computing unbiased non-price based index weights using a systematic bias control method, the method comprising the steps for each security in the plurality of securities: 1) obtaining fundamental size factors at present time (t0); 2) determining a growth rate for a period of time (t0-t-n); 3) computing a volatility-per-unit-growth rate at the present time (t0) by computing a deviation rate of the growth rate for the given stock for the period of time (t0-t-n), and then dividing the computed deviation rate by the computed growth rate; 4) computing a discount rate at the present time (t0) by (i) multiplying the computed volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given stock; 5) computing an unbiased non-price index weight at the present time (t0) by dividing the non-price based size factor at the present time (t0) by the determined discount rate at the present time (t0);

In another embodiment of a system and method for computing unbiased non-price-based index weights using a systematic bias control method is provided, the method comprising the steps for each stock in the universe of stocks: 1) obtaining fundamental size factors at present time (t0); 2) determining a growth rate for a period of time (t0-t-n); 3) computing a volatility per unit growth rate at the present time (t0) by determining a deviation rate of the growth rate for the given stock for the period of time (t0-t-n), and then dividing the determined deviation rate by the determined growth rate; 4) computing a discount rate at the present time (t0) by (i) multiplying the computed volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given stock; 5) determining a non-price based index weight at the present time (t0) by dividing the obtained non-price-based size factor at the present time (t0) by the determined discount rate at the present time (t0); 6) determining an unbiased non-price based index weight, for each stock in the universe of stocks, by selecting the higher of (i) the computed unbiased non-price index weight at present time (t0) and (ii) the a book value at present time (to).

In another exemplary embodiment of a system, method for computing unbiased non-price-based index weights, the system and method comprising the steps for each stock in the universe of stocks: a) obtaining non-price-based size factors at present time (to) from a proprietary third party database; b) structuring and storing the obtained data in a multidimensional array; c) determining a growth rate at (t0) for a period of time (t0-t-n); d) determining the deviation rate of the growth rate for the period of time (t0-t-n); e) computing a volatility per unit growth rate at present time (t0) by dividing the determined deviation rate at (t0) by the determined growth rate at present time (t0); f) computing a non-price based index weight at present time (to) by dividing the size factor at present time (t0) by (1+the volatility per unit growth rate) at present time (t0); g) structing and storing process steps a) to f) in the multidimensional array at present time (t0); h) providing instructions over the network for users via HTTPS and SFTP to download the multidimensional array comprising unbiased non-price-based index weights.

The above embodiment provides for a technical solution to systematic biases inherent in existing non-price-based indexes, e.g., fundamentally weighted and equal weighted indexes, of overweighting stocks that exhibit a low price relative to non-price-based size factors. It its understood that standard price-based-indexes do the opposite, that is, overweight securities that exhibit a high price relative to non-price-based size factors.

One or more of these and other objects are achieved by the provision of various embodiments as described herein. It should be appreciated that all combinations of the foregoing processes/methods and/or techniques and additional processes/methods and/or techniques discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 shows an exemplary securities indexing system in which various embodiments may be practiced;

FIG. 2 shows a securities indexing subsystem according to various embodiments;

FIG. 3 shows a computer-based process 300 for monitoring securities, computing unbiased non-price-based index weights and performing actions according to various embodiments;

FIG. 4 shows the computer-based process of determining unbiased non-price-based index weights according to various embodiments;

FIG. 5 shows another computer-based process for determining unbiased non-price-based index weights according to various embodiments;

FIG. 6 shows an exemplary embodiment of a multidimentional array according to various embodiments;

FIG. 6A-D shows a multidimentional array object and data structure according to various embodiments;

FIG. 7 shows an example computer-based system capable of implementing various embodiments;

FIG. 8 shows one embodiment of a process and associated computer system implementing various aspects;

FIG. 9 illustrates block diagram of an exemplary system according to an exemplary embodiment.

### DETAILED DESCRIPTION OF INVENTION

What is desired is a technique, method and system that provides for a solution to systematic bias in existing non-price-based indexes. It is further desired that the method improves the securities indexing system in the process of computing non-price-based index weights, by providing for improved system efficiency, such as reduced processing times, and memory requirements in processing non-price-based index weights. Some further embodiments relate to useful tools that can be used in one or more embodiments.

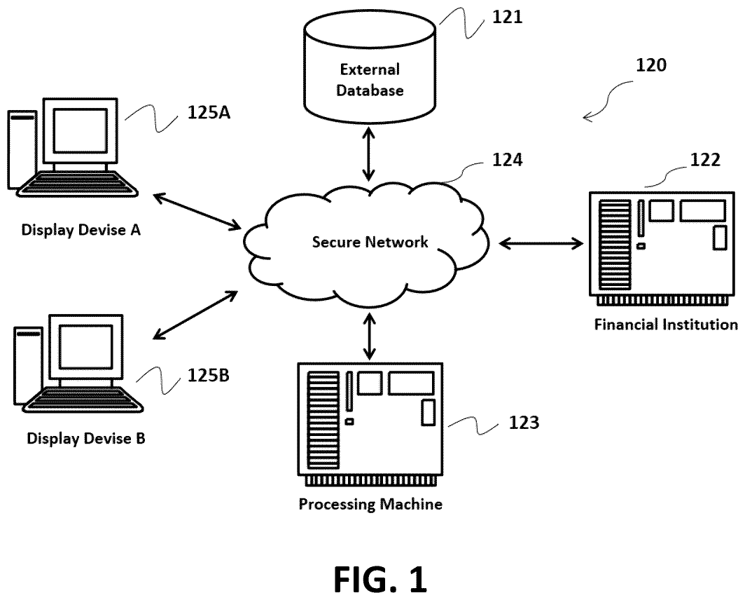

FIG. 1 shows an exemplary securities indexing system 120 in which various embodiments may be practiced. In particular, FIG. 1 shows one or more networks, (e.g., network 124), and one or more security databases 121, and such database may be accessed via network 124. A securities indexing processing machine 123 and one or more user (122) computer systems. It is understood that the securities database (i.e., the data source) is proprietary and that the embodiments, as disclosed herein, may include one or more proprietary databases and of which one or more databases may be third party proprietary databases.

In one or more embodiments, a securities indexing processing machine 123 is provided which is capable of evaluating one or more parameters relating to one or more securities and performing one or more computer-based actions in the process of computing unbiased non-price-based index weights. Information and/or signals produced by the securities indexing processing machine 123 may be accessed and/or displayed to one or more other system elements such as user device A (item 125A) which may include a portable device such as a cell phone or other mobile device. Other devices may include, for example, a user device B (item 125B) which may be a personal computer or other type of computer-based workstation. Information (process data) may be transmitted over the network 124 from the securities indexing processing machine 123 to one or more financial institutions (122) computer systems.

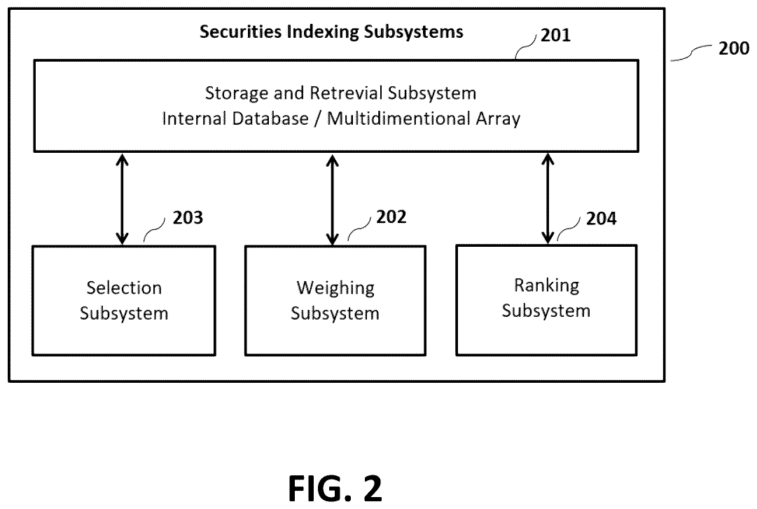

FIG. 2 shows a securities indexing subsystem according to various embodiments. The securities indexing system 123 is a computer-based special purpose machine capable of determining non-price-based index weights for a plurality of securities in an automated process (e.g., without human involvement). In particular, FIG. 2 shows an example implementation of an index management system 123 as shown above with respect to FIG. 1. According to one embodiment, securities indexing subsystem 200 includes one or more components including, but not limited to, a weighting subsystem 202, a selection subsystem 203, and a ranking subsystem 204. In one or more embodiments, the weighting subsystem 202 is capable of computing unbiased non-price-based index weights using various embodiments as disclosed herein. Weighting subsystem 202 is capable of proving for a solution to systematic bias in existing systems and methods, selection subsystem 203 is capable of selecting one or more assets to be evaluated and/or performing one or more computer-based actions associated with determined non-price-based index weights. In one or more embodiments, information relating to the securities stored within one or more external databases (e.g., securities database 121) are obtained, structured and stored in an internal database 201 using one or more multidimensional arrays, which can be stored locally or in other type of storage (e.g., cloud) in which securities data may be structured and stored. The ranking subsystem 204 associated particular securities automatically rank the weighted and selected securities and store the ranking in the internal database 201.

Securities indexing subsystem 200 may also include a ranking subsystem 204 that is capable of determining a non-price-based index weights associated with one or more securities and/or a relative ranking in relation to other securities. Weighting subsystem 202 may be capable of accessing one or more parameters associated with particular security (e.g., a security having information stored within one or more databases). Weighting subsystem 202 may be capable of determining an unbiased non-price-based index weight or ranking of a particular security based on one or more factors. As a practical example, weighting subsystem 202 may be capable of continuously and automatically retrieving structured and stored object data and processed data in real time from one or more multidimensional arrays for one or more securities associated with a group of securities. Such information may be communicated to subsystem 202 via one or more networks, memories, or storage entities.

The weighting subsystem 202 capable of determining one or more unbiased non-price-based index weights associated with one or more securities within an index of securities. As discussed herein, a non-price-based index may be described as a grouping of assets, the assets being one or more types of assets within the group. In some example implementations, the securities may include stocks. Weighting subsystem 202 may be responsive to one or more factors including parameters associated with one or more security databases, one or more non-price-based index weights determined, for example as a result of evaluations performed by one or more other entities of the securities indexing subsystem 200. Such information may include, without limitation, a non-price-based index weight of a security determines automatically and in real time responsive to received data.

In some embodiments, database 121 serves as a data source from which the system receives or obtains any necessary data for performing the methods described herein. In a further step, the system configures, structures and stores the obtained data (e.g., “raw” or “input” data) in an internal database 201 (e.g., in using a two-dimensional array or other storage structure (e.g., any order of an array, data file, flat file, object database, or other database format)) in which the data is structured for structural access by the system. In a further step, the system accesses the data (e.g., stored and structured in the multidimensional array or other storage structure) to perform step by step process that, in some embodiments, results in a determination of an unbiased non-price-based index weight. This step-by-step process, in some embodiments, transforms the input data to an unbiased non-price-based index weight in the last step (the output data).

In some embodiments, data transformation is performed by process steps that determine the volatility premium and the discount rate. These data transformation steps transform one or more obtained size factors (e.g., a net earnings or book value) to an unbiased non-price-based index weight (or other useful weighting approaches as disclosed herein). In some embodiments, the process solves problems in the prior art, in that an unbiased non-price-based index weight is determined which achieves the desired end result.

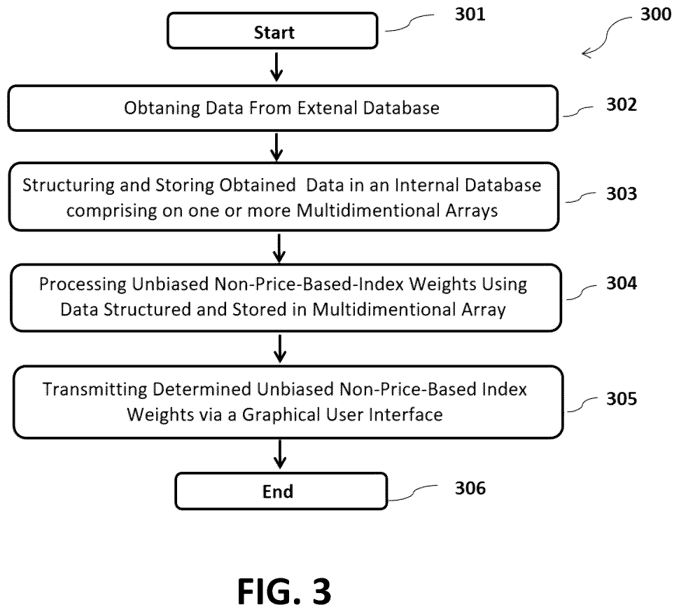

FIG. 3 shows a computer-based process 300 for monitoring securities, computing unbiased non-price-based index weights and performing actions according to various embodiments. At block 301, process 300 begins. At block 302, a system (e.g., securities indexing subsystem 200) retrieves/obtains object data from one or more proprietary databases or proprietary data sources 121. At block 303, the system structures and store obtained data in an internal data base using one or more multidimensional arrays. At block 304, the system determining unbiased non-price-based index weights (e.g., one or more securities) using data structured and stored in one or more multidimensional arrays. In one or more embodiments, the system may be capable of monitoring real-time data associated with one or more of the securities for which a non-price-based index weight have been determined. For instance, the system may be capable of monitoring factor data and other data associated with one or more securities (e.g., at block 303). At block 305, the system transmitting determined unbiased non-price-based index weights as structured and stored in multidimensional array to users via a graphical to interface users/financial institutions. At block 306, process 300 ends.

In some embodiments as described herein, there are one or more interfaces to the system. Some of these interfaces may be programmatic in nature and may couple one or more systems. In other embodiments, there are provided one or more user interfaces to the system.

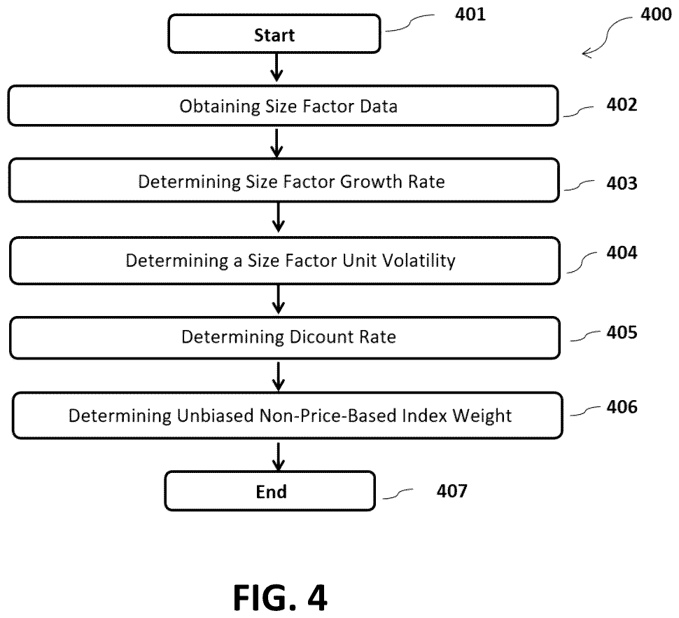

FIG. 4 shows a computer-based process 400, for determining an unbiased non-price-based index weight of a security according to various embodiments. At block 401, process 400 begins. At block 402, a system (e.g., securities indexing subsystem 200) obtains a size factor associated with one or more securities from a proprietary database 121. The size factor may be stored in one or more internal databases associated with one or more computing systems reference to FIG. 3. At block 403, the system determines a size factor growth rate associated with the security. At block 404, the system determines a size factor unit volatility factor for the security. Based on the size factor, size factor growth rate, and size factor unit volatility, the system determines the discount rate for the particular security at block 405. At block 406, the system determines an unbiased non-price-based index weight of the security based on the size factor and the determined discount rate. At block 407, process 400 ends.

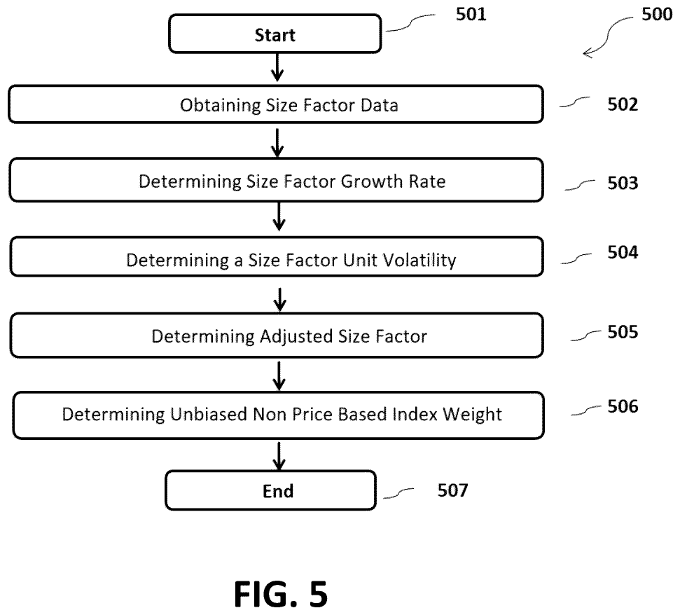

FIG. 5 shows another computer-based process 500, for determining an unbiased non-price-based index weight of a security according to various embodiments. At block 501, process 500 begins. At block 502, the system (e.g., securities indexing system 200) or some computing entity obtains a size factor associated with one or more securities from proprietary database 121. As discussed above, the size factor data may be stored in one or more internal databases or other data sources. At block 503, the system determines a size factor growth rate and a deviation rate. At block 504, the system determines a size factor growth rate unit volatility factor associated with the security. At block 505, the system determines the adjusted size factor associated with the security. At block 506, the system determines the non-price-based index weight of the security. At block 507, process 500 ends.

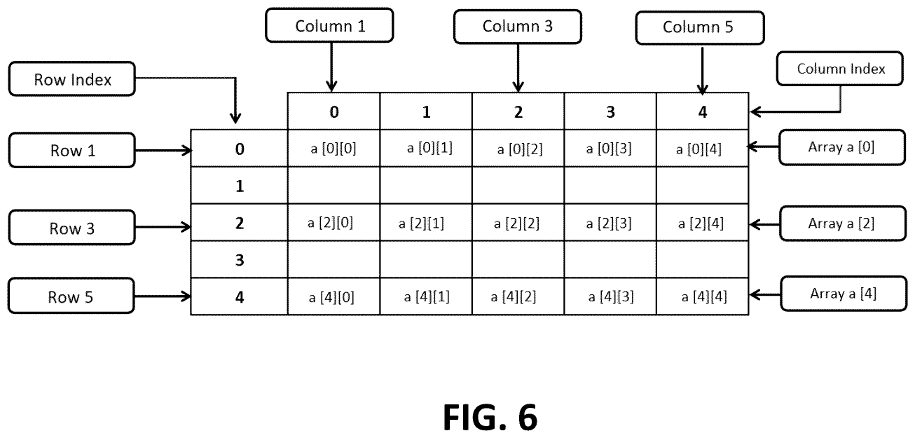

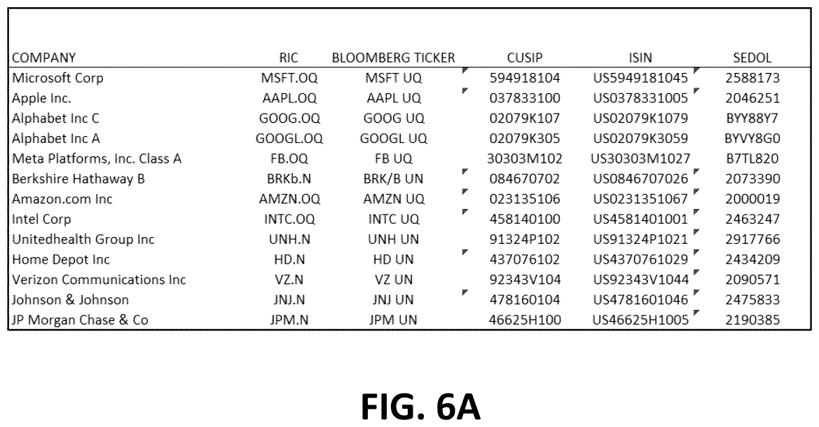

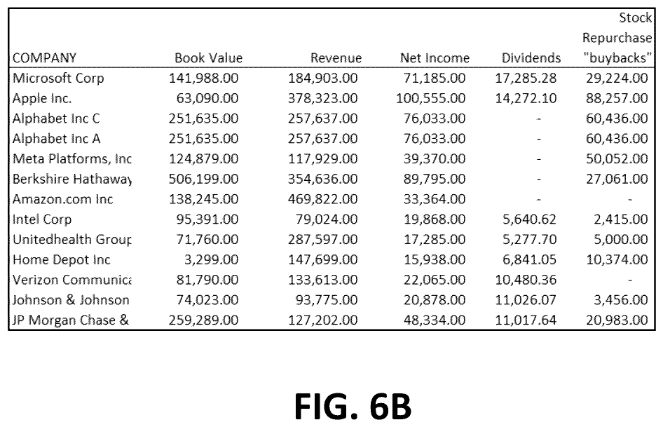

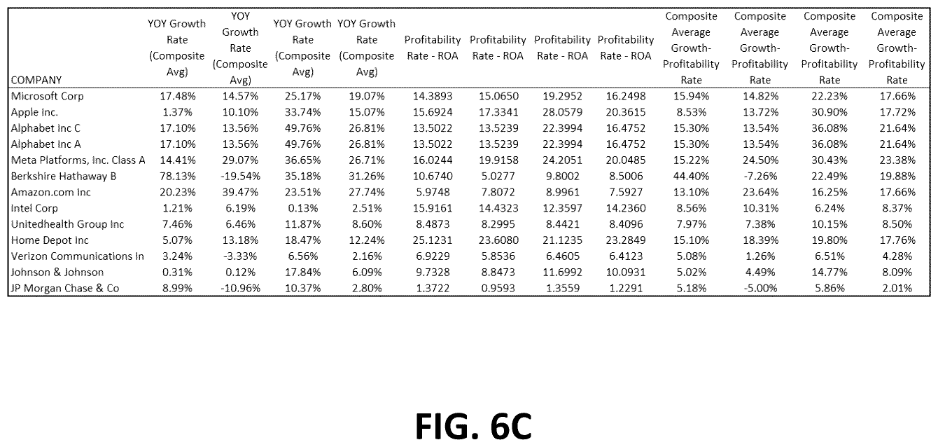

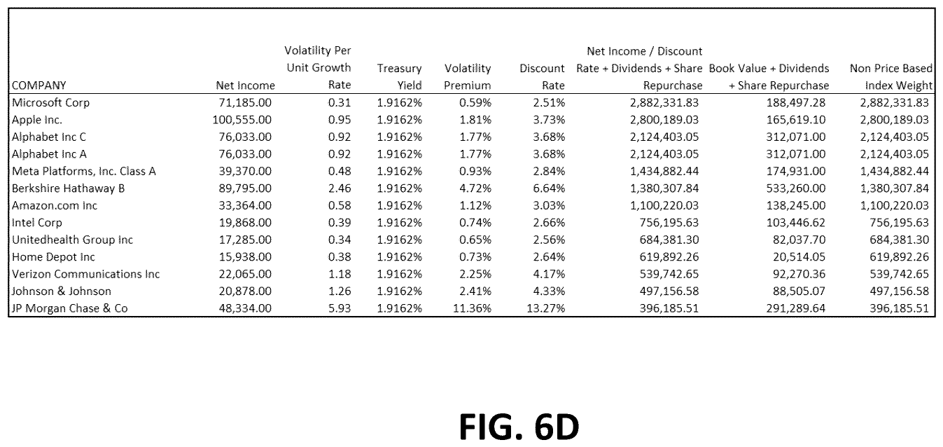

FIG. 6 shows an exemplary embodiment of a multidimensional array in where obtained data is structured and stored to efficiently aid the system process to achieve it desired end result. The system, a computer program and a memory specifically configured to structure and store obtained data according to a specifically designed logical table, said logical table including: a plurality of logical rows, each said logical row including an identification number (OID) to identify each said logical row, each said logical row corresponding to a record of information comprising a financial object, a plurality of logical columns intersecting said plurality of logical rows to define a plurality of logical cells, each said logical column including an OID to identify each said logical column providing the means for structuring and store financial objects and factor data in a multidimensional array. It is appreciated that the multidimensional array and the specifically configured memory aid the method to perform more efficiently, such as reducing processing time and memory requirements, and more accurately (avoiding processing errors and thus improving quality) in achieving the desired result.

The systems processing steps are furthermore automatically structured and stored in the multidimensional array (201) allowing for the various embodiments, as disclosed herein, to more efficiently access data without having to repeatably utilizing one or more processors to obtain new data through third party databases (121). It is appreciated herein that the multidimensional array automatically structure and store obtained data in a logical structure in a specific way to aid the processing steps. The multidimensional array furthermore stores the claimed process steps which allow the various embodiments, as disclosed herein, to access and process data more efficiently, which improves accuracy, reduces processing times, and memory requirements. It is appreciated herein that the multidimensional array in part or as a whole may be transmitted using SFTP (Secure File Transfer Protocol) server via the network (124) to the end user (122) (125A) and (125B).

FIG. 6A shows an extract of an exemplary embodiment of securities (financial objects) as structured and stored in a multidimensional array. FIG. 6B shows an extract of an exemplary embodiment in where some obtained factor data is structured and stored in a multidimensional array. FIGS. 6C and 6D shows processed data and determined non-price-based index weights (202) as structured and stored in a multidimensional array (201).

### Exemplary Computer System Embodiments

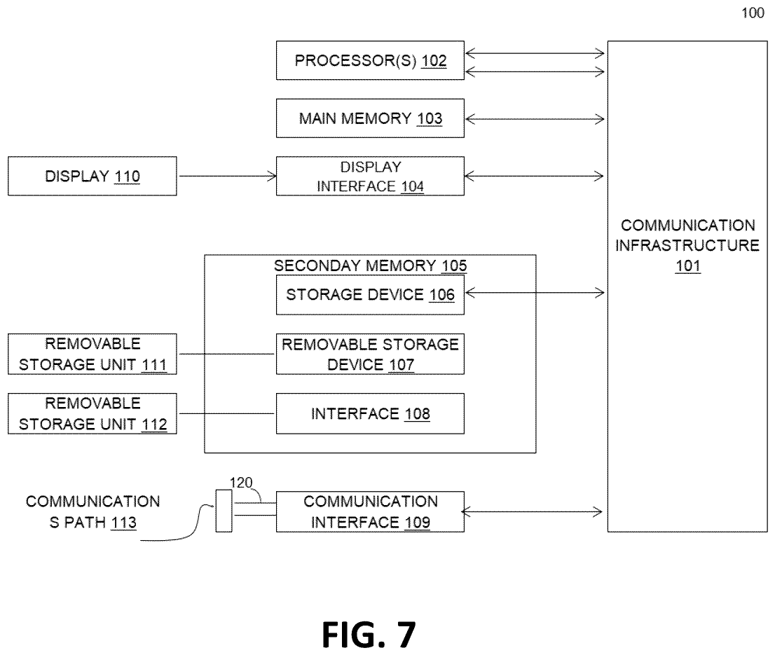

FIG. 7 shows an exemplary computer-based system capable of implementing various embodiments. In particular, FIG. 7 illustrates an exemplary computer system that may be used in implementing one or more exemplary embodiments. Specifically, FIG. 7 illustrates an exemplary embodiment of a computer system 100 that may be used in computing devices such as, e.g., but not limited to, a client and/or a server, etc., according to an exemplary embodiment of the present invention. FIG. 7 illustrates an exemplary embodiment of a computer system that may be used as client device 100, or a server device 100, etc. As described herein, the system of FIG. 7 may be used to implement any of the elements of FIG. 1 above, and is adapted to process and receive data from one or more databases (e.g., such as, for example, securities database as shown in FIG. 1).

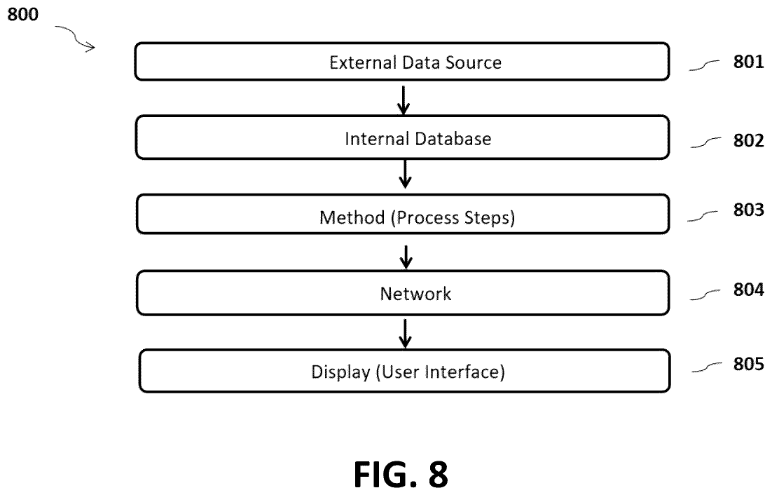

Embodiments of the present invention (or any part(s) or function(s) thereof) may be implemented using hardware, software, firmware, or a combination thereof and may be implemented in one or more computer systems or other processing systems. In fact, in one exemplary embodiment, one or more computer systems capable of carrying out the functionality described herein may be provided. An example of a computer system 100 may be shown in FIG. 8, depicting an exemplary embodiment of a block diagram of an exemplary computer system useful for implementing embodiments the present invention. Specifically, FIG. 7 illustrates an example computer 100, which in an exemplary embodiment may be, e.g., (but not limited to) a personal computer (PC) system running an operating system such as, e.g., (but not limited to) MICROSOFT® WINDOWS® operating systems, etc. available from MICROSOFT® Corporation of Redmond, Wash., U.S.A. However, the invention may not be limited to these platforms. Instead, the invention may be implemented on any appropriate computer system running any appropriate operating system.

In one exemplary embodiment, the present invention may be implemented on a computer system operating as discussed herein. An exemplary computer system, computer 100 may be shown in FIG. 7. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 7. Services may be provided on demand using, e.g., but not limited to, an interactive television (iTV), a video on demand system (VOD), and via a digital video recorder (DVR), or other on demand viewing system.

The computer system 100 may include one or more processors, such as, e.g., but not limited to, processor(s) 102. The processor(s) 102 may be connected to a communication infrastructure 101 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 100 may include a display interface 104 that may forward, e.g., but not limited to, graphics, text, and other data, etc., from the communication infrastructure 101 (or from a frame buffer, etc., not shown) for display on the display unit 110.

The computer system 100 may also include, e.g., but may not be limited to, a main memory 103, random access memory (RAM), and a secondary memory 105, etc. The secondary memory 105 may include, for example, (but not limited to) a hard disk drive 106 and/or a removable storage drive 107, representing any type of memory, storage element, or media including storage drives or devices including magnetic, optical or other types of memory elements. The removable storage drive 107 may, e.g., but not limited to, read from and/or write to a removable storage unit (111) in a well-known manner. Removable storage unit 111, also called a program storage device or a computer program product, may represent, e.g., but not limited to, a FLASH drive, a disk, magnetic tape, optical disk, compact disk, or other storage element which may be read from and written to by removable storage drive 107. As may be appreciated, the removable storage unit 111 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and/or a memory chip, or other media type.

In alternative exemplary embodiments, secondary memory 105 may include other similar devices for allowing computer programs or other instructions to be loaded into computer system 100. Such devices may include, for example, a removable storage unit 112 and an interface 108. Examples of such may include a program cartridge and cartridge interface (such as, e.g., but not limited to, those found in video game devices), a removable memory chip, element or drive, and other removable storage units 112 and interfaces 108, which may allow software and data to be transferred from the removable storage unit 112 to computer system 100.

Computer 100 may also include an input device 140 such as, e.g., (but not limited to) a mouse or other pointing device such as a digitizer, and a keyboard or other data entry device (not shown). Computer 100 may also include output devices, such as, e.g., (but not limited to) display 110, and display interface 104. Computer 100 may include input/output (I/O) devices such as, e.g., (but not limited to) communications interface 109, cable 120 and communications path 113, etc. These devices may include, e.g., but not limited to, a network interface card, and modems (neither are labeled). Communications interface 109 may allow software and data to be transferred between computer system 100 and external devices.

In this document, the terms “computer program medium” and “computer readable medium” may be used to generally refer to media such as, e.g., but not limited to removable storage drive 107, a hard disk installed in hard disk drive 106, and signals 120, etc. These computer program products may provide software to computer system 100. The invention may be directed to such computer program products. In some embodiments, such a computer-readable medium may be a non-volatile medium as is known in the art.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, objects or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes. In yet another exemplary embodiment, the invention may be implemented using a combination of any of, e.g., but not limited to, hardware, firmware and software, etc. In one or more embodiments, the present embodiments are embodied in machine-executable instructions. The instructions can be used to cause a processing device, which is programmed with the instructions, to perform the steps of the present invention. Alternatively, the steps of the present invention can be performed by specific hardware components that contain hardwired logic for performing the steps, or by any combination of programmed computer components and custom hardware components. In this environment, the embodiments can include a machine-readable medium having instructions stored on it. The instructions can be used to program a processor or processors (or other electronic devices) to perform a process or method according to the present exemplary embodiments.

### Exemplary Communications Embodiments

In one or more embodiments, the present embodiments are practiced in the environment of a computer network or networks. The network can include a private network, or a public network (for example the Internet, as described below), or a combination of both. The network includes hardware, software, or a combination of both. From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called inter-process communication pathways. On these pathways, appropriate communications protocols are used. The distinction between hardware and software may not be easily defined, with the same or similar functions capable of being performed with use of either, or alternatives.

An exemplary computer and/or telecommunications network environment in accordance with the present embodiments may include node, hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently.

In an exemplary embodiment, the processes may communicate with one another through inter-process communication pathways (not labeled) supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including BlackBerry or other types of devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

### Improved Computer System

In some embodiments, an improved securities indexing system is provided for processing non-price-based index weights. In particular, an improvement is provided by a new process and by the use of a specifically configured internal database that through a specifically configured memory aid the various embodiments processing steps to improve the efficiency, i.e., the overall transmission, storage and processing of data, by reducing computer processing needs and reducing (RAM) memory requirements. Further, the internal database comprises transformed financial objects, by the various embodiments, as disclosed herein.

FIG. 8 shows one embodiment of a process and associated computer system implementing various aspects. At block 801, the system retrieves (obtain) data objects from one or more external data sources, which may include one or more proprietary databases which further may be third party proprietary databases. The system restructures data objects and stores it in one or more internal database structures at block 802. For instance, as discussed herein, data objects may be stored in one or more multidimensional arrays. At block 803, the system may perform one or more processing steps which may result in a transformation of one or more data objects. Further, at block 804, one or more of the transformed data objects, as structured and stored in the multidimensional array, may be transmitted in real time to one or more users/financial institutions. Further, one or more user interfaces (805) may be configured to receive the transformed data objects where they may be displayed to a user or used by a further computer-based entity (e.g., an executing process). The multidimensional array comprising transformed data objects may be transmitted, and saved electronically and downloaded by users/financial institutions computer system.

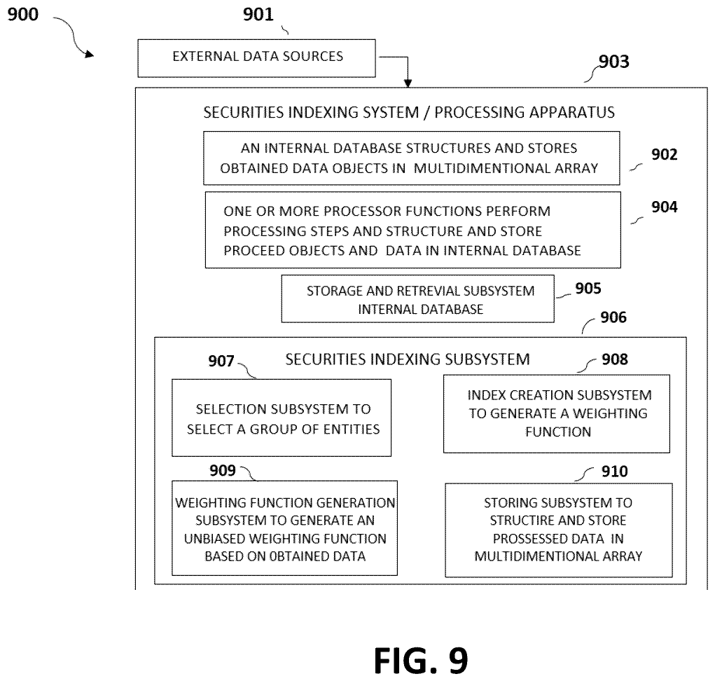

FIG. 9 illustrates block diagram of an exemplary system according to an exemplary embodiment. The system includes an external database 901 that, have stored within an aggregated accounting-based data and/or other data, metrics, measures, parameters, technical parameters, characteristics and/or factors about a plurality of entities. One or more processors obtain data from an external data source 901. The system may include an analysis host computer processing apparatus 903 coupled to the internal database 902 which structure and store obtained data in the internal databased 902. The analysis host computer processing apparatus 903 may include a data retrieval and storage subsystem 905, according to an exemplary embodiment, which may retrieve the aggregated data from the internal database and may structure and store the aggregated obtained data to the internal database 902.

The analysis host computer processing apparatus 903 may include, according to an exemplary embodiment, an securities indexing subsystem 906, which may include, according to an exemplary embodiment, a selection subsystem 907 operative to select a group of the entities based on non-market capitalization objective measure of scale or size metric including one or more technical parameters and/or metrics; a weighting function generation subsystem 908, according to an exemplary embodiment, may be operative to generate a weighting function based on non-market capitalization, non-price related objective measure of scale and/or size metric; an exemplary index creation subsystem 909, according to an exemplary embodiment, may be operative to create a unbiased non-market capitalization non-price objective measure of scale index based on the group of selected entities and/or the weighting function; and/or a storing subsystem 910, according to an exemplary embodiment, operative to structure and store processed data in multi-dimensional array of data objects. The index or array of data objects may be stored on a storage device, in one exemplary embodiment. According to one exemplary embodiment, the system may further include storage and retrieval processing unit 905 operative to structure and store processed object data in internal database 902.

### Exemplary Process Control System

According to an exemplary embodiment, the system may be used to compute using object data input via an input/output subsystem, a multi-dimensional array storing database system for storage of a multi-dimensional array computed via a multi-dimensional object array creation subsystem comprising a selection subsystem operative to select one or more objects based on one or more technical parameters, and a weighting subsystem operative to weight the selected one or more objects based on one or more technical parameters, wherein the technical parameters are chosen such that the technical parameters avoid influence of an undesirable predetermined technical criterion and/or criteria, so as to avoid influence of the undesirable predetermined technical criterion and/or criteria. As a result of elimination of the undesirable predetermined technical criterion and/or criteria, the multi-dimensional array selected and/or weighted to avoid influence of the undesirable predetermined technical criterion and/or criteria may as a result perform processing from negative effects from the undesirable predetermined technical criterion and/or criteria. An exemplary embodiment of the selection subsystem may be operative to select objects from a predetermined universe of objects to obtain a subset of the universe, where the selection is based on a technical parameter that is not influenced by the undesirable technical criterion and/or criteria. Following execution of the selection subsystem, according to an exemplary embodiment, an exemplary weighting subsystem may operative to weight the resulting selected objects by a weighted combination of two or more technical weighting criteria, which are not influenced by the undesirable technical criterion and/or criteria. The process may be used for such technical processes as may include, e.g., but are not limited to, industrial automation, production process automation, a manufacturing process, and/or a chemical processing system, among others as described elsewhere, herein.

Table 3 below illustrates an exemplary embodiment of a system and method providing for a solution to systematic bias inherent in existing non-price-based indexing systems. Existing non-price-based systems and methods, as illustrated in table 3, i.e., security A and B, weight stocks based on one or more non-price-based size factors, such as net earnings, book value, cash flow, dividends and the like. As illustrated in table 3, security A and B exhibit the same size factor, i.e., net earnings ($10), and thus would be assigned the same non-price-based index weights in existing systems. However, security A and B exhibit heterogenous earnings growth and volatility (deviation rate). By not considering these factors, existing non-price-based index systems and methods create a systematic bias relative to standard price-based indexes as illustrated.

One or more embodiments, as disclosed herein, controls for systematic bias by controlling for heterogeneous factors, such a growth and volatility, across security A and B in a specific way. This is achieved by determining a deviation per unit growth rate and a discount rate independent from a market price and then discounting the size factor, the net earnings ($10), by the discount rate. By applying this method, a closer correlation between non-price-based index weights and price based index weights can be achieved, as exemplified and illustrated in table 3.

TABLE 3
Illustrates, a method for controlling for systematic bias, by controlling
for heterogenous performance factors across securities.

| Factors/Variables | Security A | Security B |
|---|---|---|
| Net Earnings (a Size Factor) (Non-Price-Based | 10.00 | 10.00 |
| Index Weight “existing methods”) | | |
| Earnings Growth Rate | 15.00% | 5.00% |
| Earnings Deviation Rate (a.k.a. volatility rate) | 5.00% | 15.00% |
| Volatility Per-Unit-Growth Rate | 0.33 | 3.00 |
| Volatility Premium | 0.83% | 7.50% |
| Risk Free Rate | 2.50% | 2.50% |
| Discount Rate | 3.33% | 10.00% |
| Price-Based-Index Weight | 300.00 | 100.00 |
| Non-Price-Based-Index Weight | 300.00 | 100.00 |

As exemplified and illustrated in table 3, existing non-price-based indexation systems and methods, which determines index weights based on accounting-based size factors (e.g., net earnings) as illustrated. Accordingly, existing non-price-based indexation systems and methods assign the same index weight for both Securities A and B (that is because the size factor is the same for both securities) while the standard price-based index weight for security A is higher (300). As a result, existing non-price-based indexation systems and methods inherit a systematic bias towards securities exhibiting a low price-based index weight relative to the size factor (net earnings) and thus overweight security B relative to security A. It is appreciated that Security B exhibit lower earnings growth and higher volatility than security A. Hence, the systematic bias in existing non-price-based indexation systems can further be explained by that they assigning higher weights to securities exhibit lower earnings growth and/or higher volatility as illustrated in table 3.

Some embodiments are directed to a new method for determining a discount rate. The discount rate comprises of a volatility premium and a risk-free rate. The volatility premium, which comprises the volatility per-unit-growth rate, allows the method to control for heterogenous performance factors, such as growth, volatility and profitability across securities. It is appreciated herein that a volatility premium leads to a lower discount rate and a higher non-price-based index weight, all else equal. Conversely, a higher volatility premium leads to a higher discount rate and a lower non-price-based index weight.

In one embodiment a system, method and computer program product for determining unbiased non-price-based index weights for individual securities, the method comprising the steps for each security in the universe of securities: 1) obtaining a net earnings at present time (t0); 2) determining an earnings growth rate for a period of time (t0-t-n); 3) determining an earnings volatility per unit growth rate at the present time (t0) by calculating a deviation rate of the earnings growth rate for the given stock for the period of time (t0-t-n), and then dividing the calculated earnings deviation rate by the determined earnings growth rate; 4) determining a discount rate at the present time (t0) by (i) multiplying the determined earnings volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given stock; 5) determining an earnings based non-price-based index weight at the present time (t0) by dividing the obtained net earnings at the present time (t0) by the determined discount rate at the present time (to).

In one embodiment a system, method and computer program product for determining unbiased non-price-based index weights for individual securities, the method comprising the steps for each stock in the universe of stocks: 1) obtaining a net earnings and a book value at present time (t0); 2) determining an earnings growth rate for a period of time (t0-t-n); 3) determining an earnings volatility per unit growth rate at the present time (t0) by calculating a deviation rate of the earnings growth rate for the given stock for the period of time (t0-t-n), and then dividing the calculated earnings deviation rate by the determined earnings growth rate; 4) determining a discount rate at the present time (t0) by (i) multiplying the determined earnings volatility per unit growth rate by a Risk Free Rate at the present time (t0) and said multiplying generating a volatility premium, and (ii) adding the generated volatility premium to the Risk Free Rate at the present time (t0), said adding resulting in the determined discount rate at the present time (t0) for the given stock, such that the discount rate is determined exclusive of a market price of the given security; 5) determining an earnings based non-price based index weight at the present time (t0) by dividing the obtained net earnings at the present time (t0) by the determined discount rate at the present time (t0). 6) adding distributions at present time (t0) to the determined earnings based non-price based index weight at present time (t0) and to the obtained book value at present time (t0); 7) determining a non-price index weight, by selecting the higher of (i) the determined earnings based non-price based index weight that is adjusted for distributions at present time (t0) and (ii) the obtained book value that is adjusted for distributions at present time (t0); 8) generating an non-price based index at present time (t0) by ranking, in descending order, each security in the universe of stocks by its determined non-price-based index weight.

In one embodiment a system, method and computer program product for computing unbiased non-price-based index weights for individual securities, the method comprising the steps for each given stock in the universe of stocks: a) obtaining a size factor at present time (to) from an external data source; b) storing the obtained size factor in a multidimensional array; c) determining a growth rate at (t0) for a period of time (t0-t-n); d) determining the deviation rate of the growth rate for the period of time (t0-t-n); e) computing a volatility per unit growth rate at present time (t0) by dividing the determined deviation rate at (t0) by the determined growth rate at present time (t0); f) computing an adjusted size factor, at present time (to), by discounting the size factor at present time (t0) by (1+the volatility per unit growth rate) at present time (t0); structuring and storing the process steps d to f in a multidimensional array, at present time (t0).

In one embodiment a system, method and computer program product for computing unbiased non-price-based index weights for individual securities further comprise discounting the adjusted size factor by a risk free rate at present time (t0). Another embodiment may further comprise providing instructions over the network to users via HTTPS and SFTP to download the multidimensional array comprising structured and stored object data, processed data and unbiased non-price-based index weights.

Object data (or data objects), may refer to a size factor or fundamental size factor, which in turn refers to accounting-based factors found in a company's income statement, balance sheet, cash flow statement or the like. A size factor may be a company's last reported revenues, earnings before interest and taxes, net earnings, cash flow, book value (shareholders equity), dividends, etc. Fundamental size factors may be reported quarterly, annually and on a trailing twelve months (TTM) basis. A composite of size factors may be an equally weighted average of two or more fundamental size factors. A fundamental size factor may also be referred to as a “size factor” in this application.

In a preferred embodiment a company's trailing twelve months (TTM) net earnings is the size factor. Various alternatives may be used, such as earnings before interest, amortization and taxes (EBITA), core earnings (i.e., earnings that excludes extraordinary or one-time earnings) and the like. Net earnings may also be referred to as net income.

It is appreciated herein that sometimes a company may exhibit negative earnings and thus the fundamental size factor is negative and the determined non-price-based index weight will consequently also be negative. Under such circumstances a company's book value may be the most appropriate non-price-index weight. A book value may furthermore be adjusted for distributions. In the case a company (within an investable universe of stocks) should exhibit both a negative net earnings and at the same time a negative book value, it is appreciated herein that such a company does not exhibit any quantifiable fundamental size factor to determine a non-price-based index weight. However, such cases are extremely rare. Based on applicant's experience, by computing non-price-based index weights based on equities comprising a broad equity universe (e.g., Russell 1000 constituents), more than 80% of the securities non-price-based index weight would be determined based on earnings, i.e., an earnings-based index weight. The remaining securities non-price-based index weights would be based in the securities (companies) tangible book value adjusted for distributions.

A growth rate may be determined as the average growth rate based on one or more size factors over an ex-post period of time. The ex-post growth rate measurement may be based on a company's quarterly data. An ex-post period may be three to six calendar years. The growth rate may be based on calendar years data and trailing twelve-month (TTM) data, and where the TTM data is used for the most recent period. The growth rate may further be based on one or more profitability factors or a combination of one or more size factors and profitability factors. Profitability factors may be a company's return on equity (ROE), return on assets (ROA), return on invested capital (ROIC) or the like.

Because sufficient profitability is necessary for sustaining long-term growth, it may be advantageous to consider profitability when determining a growth rate. It is appreciated herein that if a stock exhibits high growth rate in revenues and earnings and a low profitability rate would result a lower growth rate as the lower profitability factor would lower the average growth rate for the stock as compared with a growth rate that is determined only by growth in revenues and earnings. It is further contemplated that “growth” stocks, exhibit higher growth in revenues and earnings and higher profitability, while “value” stocks exhibit lower growth rates in revenues and earnings and low profitability rates. It is contemplated that so-called “blend” stocks generally exhibit low growth rates but higher profitability rates.

A growth rate may be determined as (i) an average growth rate (ii) a compounding annual growth rate (CAGR), (iii) a mean growth rate, (iv) a median growth rate, (v) a mode growth rate (vi) or similar measures. It is further contemplated that a growth rate may be negative. It is appreciated herein that a negative growth rate would result in a negative (i) volatility per unit growth rate, (ii) a negative volatility premium, (iii) a negative discount rate and (iv) a negative non-price-based index weight. It is appreciated herein that under these circumstances a company's last reported book value (shareholders equity) may be the proxy of the company's non-price-based index weight. In a preferred embodiment the growth rate is determined by calculating the composite average growth rate of; (i) revenues, (ii) net earnings and (iii) return on assets (ROA). Table 4 illustrates an exemplary embodiment for determining a growth rate based on two fundamental size factors, revenues and net earnings and one profitability factor, return on assets (ROA).

TABLE 4
Illustrates an exemplary embodiment of determining a growth rate
Amounts in $ million: Obtained Data: FactSet (obtained from external database)

| Ref. | | | 2013 | 2014 | 2015 | 2016 | TTM | AVERAGE |
|---|---|---|---|---|---|---|---|---|
| 1 | Obtained data | Revenue | $71,312 | $74,331 | $70,074 | $71,890 | $72,174 | $72,117 |
| 2 | Obtained data | Net Income | $13,831 | $16,323 | $15,409 | $16,540 | $16,505 | $16,194 |
| 3 | Computation | Composite Average | $42,572 | $45,327 | $42,742 | $44,215 | $44,340 | $44,156 |
| | | (ref. 1&2) | | | | | | |
| 4 | Computation | YOY Growth Rate | | 6.47% | −5.70% | 3.45% | 0.28% | 1.12% |

| | | | | | | | |
|---|---|---|---|---|---|---|---|
| 5 | Obtained data | Profitability Return | 12.41% | 11.68% | 12.05% | 11.75% | 11.97% |
| | | on Assets (ROA) | | | | | |
| 6 | Computation | Composite Average Growth- | 9.44% | 2.99% | 7.75% | 6.02% | 6.55% |
| | | Profitability Rate (ref. 4&5) | | | | | |

In some embodiments, the volatility-per-unit-growth rate combines multiple factors. These factors may include, fundamental growth factors, such as growth in revenues and earnings, profitability, such as return on assets (ROA), and fundamental growth volatility (i.e., the deviation rate). The volatility-per-unit-growth rate is determined by calculating a deviation rate of the growth rate for a given stock over an ex-post period of time (t0-t-n), and then dividing the calculated deviation rate by the determined growth rate. The resulting measure considers the quality (or sustainability) of growth, by considering not only growth per se, but also profitability and volatility. It is appreciated herein that the volatility per-unit-growth rate may also be referred to as a size factor unit volatility factor in this application.

It is appreciated herein that growth volatility may also referred to as the deviation rate in this application. It is further appreciated herein that a risk-free asset exhibits no (zero) volatility-per-unit-growth rate. In this way the volatility per-unit growth measure further links to the risk-free rate (i.e., the risk-free growth rate).

In one embodiment, the deviation rate of the growth rate may be determined as either a standard deviation or a semi deviation. It may be preferred to exclude profitability factors when determining the deviation rate. Hence, the deviation rate may be calculated based on a composite average measure of (i) revenues and (ii) net earnings only.

It is appreciated herein that a high growth rate and a low deviation rate results in a low volatility per unit growth rate, and a low volatility premium, and a low discount rate and thus a high determined non-price index weight for a company, all else equal. Conversely, a low growth rate and a high deviation rate results in a high volatility-per-unit-growth rate, a higher volatility premium, a higher discount rate and this a lower determined non-price-based-index weight, all else equal. It is appreciated that the deviation rate may also be referred to as a volatility rate in this application.

In one embodiment, the discount rate comprises of a volatility premium and the risk-free rate. The volatility premium controls for individual stocks heterogeneous performance factor through the volatility-per-unit-growth rate. A high volatility premium indicates high volatility and a low volatility premium indicates low volatility. A security that exhibits zero volatility per unit growth is per definition a risk-free asset. The risk-free rate controls for macroeconomic risk which is common for all securities. The discount rate is determined by multiplying the determined volatility-per-unit-growth rate by a risk-free-rate at the present time (t0) and said multiplying generating a volatility premium, and (ii) adding the generated volatility premium to the risk-free rate at the present time (t0), said adding resulting in the determined discount rate at the present time (t0) for individual securities. It is appreciated herein that the volatility premium and the discount rate is determined independent from investors assessment, i.e., independent from the market price of the security. Table 5 below illustrates the relationship between the volatility premium and the discount rate across two risky assets (stocks) and one risk free asset.

TABLE 5
Illustrates the relationship between the volatility premium
and the discount rate across two risky assets (stocks)
and one risk free asset (e.g., Treasury note).

| | Risky | Risky | Risk Free |
|---|---|---|---|
| Factors/Variables | Asset A | Asset B | Asset C |
| Growth Rate | 5.00% | 15.00% | 2.50% |
| Deviation Rate | 15.00% | 5.00% | 0.00% |
| Volatility-Per-Unit-Growth Rate | 3.00 | 0.33 | 0.00 |
| Risk-Free Rate | 2.50% | 2.50% | 2.50% |
| Volatility Premium | 7.50% | 0.83% | 0.00% |
| Discount Rate | 10.00% | 3.33% | 2.50% |

As shown in table 5, risky Asset A exhibits a higher volatility-per-unit-growth rate, a higher volatility premium and a higher discount rate, relative to risky Asset B. The risk-free Asset C exhibits, contrary to Asset A and B, a zero-deviation rate, and thus exhibits a volatility-per-unit-growth rate that is zero, and a volatility premium that is zero and is for that reason considered risk free. That is, a risk-free asset exhibits a given growth rate which does not carry any volatility (i.e., deviation rate). It is appreciated herein that the volatility-per-unit-growth rate and the volatility premium allows for an improved determination of a discount rate across securities that exhibit heterogeneous performance factors, such as profitability, growth and volatility and across securities and bonds.

The non-price-based index weight for a stock is determined by discounting a size factor, such as net earnings, by the determined discount rate. It is appreciated herein that discounting a size factor by the determined discount rate provide for a solution to systematic bias inherent in existing non-price-based indexing system and methods. It is further appreciated herein that the non-price-based index weight is determined without reference to a securities market price, i.e., without reference to human assessment and thus is not subject to behavioral biases (also known as cognitive biases) which may be (more or less) inherent in standard price-based indexes.

Table 6 below illustrates size factor weights, non-price-based index weights (as determined by an exemplary embodiment herein) and a price-based index weight as of Dec. 31, 2021 for the 30 largest US companies as measured by non-price-based index weights. The size factor weights are book value, revenues, net earnings and dividends. These are size factors used in existing non-price-based indexes, such as fundamentally weighted index benchmarks, in where one or more size factor weights may be used. For example, a fundamental weighted index may determine non-price-based index weights by weighting securities based on their book value while others my combine two or more size factors.

TABLE 6
Illustrates size factor weights, unbiased non-price-based index weights (as disclosed
in this application) and price-based index weights as of Dec. 31, 2021 for the 30
largest US companies as measured by non-price-based index weights. Amounts in USD.

| | | | | | Unbiased | |
|---|---|---|---|---|---|---|
| | | | | | Non-Price- | Price- |
| | Book | | Net | | Based Index | Based-Index |
| COMPANY | Value | Revenue | Earnings | Dividends | Weight | Weight |
| Microsoft Corp | 141,988 | 184,903 | 71,185 | 17,285 | 2,882,332 | 2,525,084 |
| Apple Inc. | 63,090 | 378,323 | 100,555 | 14,272 | 2,800,189 | 2,913,284 |
| Alphabet Inc C | 251,635 | 257,637 | 76,033 | 0 | 2,124,403 | 1,790,861 |
| Alphabet Inc A | 251,635 | 257,637 | 76,033 | 0 | 2,124,403 | 1,790,861 |
| Meta Platforms, Inc. | 124,879 | 117,929 | 39,370 | 0 | 1,434,882 | 795,898 |
| Berkshire Hathaway | 506,199 | 354,636 | 89,795 | 0 | 1,380,308 | 669,122 |
| Amazon.com Inc | 138,245 | 469,822 | 33,364 | 0 | 1,100,220 | 1,691,003 |
| Intel Corp | 95,391 | 79,024 | 19,868 | 5,641 | 756,196 | 209,451 |
| Unitedhealth Group Inc | 71,760 | 287,597 | 17,285 | 5,278 | 684,381 | 472,941 |
| Home Depot Inc | 3,299 | 147,699 | 15,938 | 6,841 | 619,892 | 433,370 |
| Verizon Communications Inc | 81,790 | 133,613 | 22,065 | 10,480 | 539,743 | 218,128 |
| Johnson & Johnson | 74,023 | 93,775 | 20,878 | 11,026 | 497,157 | 450,358 |
| JP Morgan Chase & Co | 259,289 | 127,202 | 48,334 | 11,018 | 396,186 | 467,966 |
| Procter & Gamble | 46,514 | 78,346 | 14,510 | 8,239 | 329,447 | 395,855 |
| United Parcel Service Inc | 14,253 | 97,287 | 12,890 | 3,549 | 318,827 | 156,288 |
| AbbVie Inc. | 15,408 | 56,197 | 11,542 | 9,189 | 318,210 | 239,371 |
| Northrop Grumman Corp | 12,926 | 35,667 | 7,005 | 980 | 303,194 | 61,365 |
| Visa Inc A | 34,509 | 25,477 | 13,144 | 2,828 | 301,452 | 361,346 |
| Walmart Inc. | 80,925 | 571,962 | 8,020 | 6,129 | 300,640 | 401,352 |
| Philip Morris International | −10,106 | 31,651 | 9,109 | 7,625 | 299,740 | 147,899 |
| Morgan Stanley | 97,691 | 61,121 | 15,034 | 3,796 | 291,481 | 176,139 |
| Anthem Inc | 36,060 | 138,639 | 6,104 | 1,100 | 290,306 | 112,508 |
| Goldman Sachs Group Inc | 99,223 | 64,989 | 21,635 | 2,271 | 282,979 | 128,075 |
| Bank of America Corp | 245,358 | 93,851 | 31,978 | 6,501 | 278,956 | 359,383 |
| Oracle Corp | 5,238 | 41,399 | 10,262 | 3,328 | 278,773 | 232,890 |
| QUALCOMM Inc | 9,950 | 36,036 | 9,987 | 3,065 | 267,285 | 204,814 |
| Comcast Corp A | 96,092 | 116,385 | 14,159 | 4,480 | 257,071 | 227,682 |
| Pfizer Inc | 77,201 | 81,288 | 22,413 | 8,745 | 251,982 | 331,440 |
| Eli Lilly & Co | 8,979 | 28,318 | 5,582 | 3,082 | 245,698 | 264,230 |
| Cisco Systems Inc | 41,275 | 50,789 | 11,397 | 6,200 | 238,689 | 267,270 |
| Total | 2,974,719 | 4,499,199 | 855,474 | 162,948 | 22,195,022 | 18,496,233 |

Table 6, illustrates that existing non-price-based index weights, based on size factors, book value, revenues, net earnings and dividends, deviate substantially from standard price-based index weights across these securities.

As a result, existing non-price-based indexes inherit a systematic bias towards securities that exhibit a low price-based index weight relative for the size factor weights. In other words, existing non-price-based indexes inherit a systematic bias by overweighting securities that exhibit a low market price relative to the size weight, e.g., earnings. As further illustrated in table 6, the determined unbiased non-price-index-weights (as per embodiments disclosed herein) better proxy price-based index weights, i.e., have a closer correlation to the conventional price-based index 10 weights.

In this application, dividends and buybacks are collectively referred to as “distributions”. The term “distributions” refer to dividends and buybacks paid (or performed) by a company. The sum of dividends and buybacks most recently paid or performed by a company may be added to (i) the determined earnings based non-price-based index weight and to (ii) the most recently reported book value. The book value refers to a company's shareholders equity (a.k.a. net worth).

In a preferred embodiment distributions are determined for each individual stock by adding the trailing twelve months paid dividends to the trailing twelve months performed buybacks. The sum of these two factors is subsequently added to each stocks determined unbiased non-price-based index weight and to its most recently reported book value.

In one or more embodiments, the higher of the determined earnings based non-price-based index weight and the most recently reported book value represents the non-price-based index weight. In this application it is appreciated that the term “company”, the term “stock” and the term “security” and the term ‘entity’ may mean the same thing and may be used interchangeably throughout various discussions in this application.

In one embodiment of a system, method and computer system for determining unbiased non-price-based index weights, the method comprising the steps for each security in the universe of securities: 1) obtaining a size factor at present time (t0); 2) determining a growth rate at (t0) for a period of time (t0-t-n); 3) determining the deviation rate of the growth rate for the period of time (t0-t-n); 4) determining a volatility per-unit growth rate at present time (t0) by dividing the determined deviation rate at (t0) by the determined growth rate at present time (t0); 5) determining an unbiased size factor at present time (to) by dividing the obtained size factor at present time (t0) by 1+the volatility per unit growth rate at present time (to).

In one embodiment of a system, method and computer system for determining unbiased non-price-based index weights, the method comprising the steps for each security in the universe of securities: 1) obtaining a size factor at present time (t0); 2) determining a growth rate at (t0) for a period of time (t0-t-n); 3) determining the deviation rate of the growth rate for the period of time (t0-t-n); 4) determining a volatility per-unit growth rate at present time (t0) by dividing the determined deviation rate at (t0) by the determined growth rate at present time (t0); 5) determining an adjusted size factor at present time (to) by dividing the size factor at present time (t0) by 1+the volatility per unit growth rate at present time (t0); 6) determining an unbiased non-price-based index weight at present time (to) by dividing the adjusted size factor at present time (to) by the risk free rate at present time (to).

The above embodiment provides for a solution to systematic bias inherent in existing non-price-based index systems and methods by controlling for heterogeneous factors, such as size factor growth and volatility, across individual securities.

Table 7 below illustrates an alternative embodiment for controlling for systematic bias across two securities exhibiting heterogeneous volatility rates and growth rates, and where the size factor is adjusted for volatility using the determined volatility-per-unit-growth measure.

TABLE 7
illustrates one embodiment for controlling for
systematic bias in existing systems and methods

| Ref: | Factors/Variables | Stock A | Stock B |
|---|---|---|---|
| A | Size Factor (existing “prior art” methods) | $100.00 | $100.00 |
| B | Growth Rate | 10.00% | 5.00% |
| C | Volatility Rate (a.k.a. Deviation Rate) | 5.00% | 10.00% |
| D | Volatility Per-Unit Growth Rate (C/B) | 0.50 | 2.00 |
| E | Adjusted Size Factor (A/(1 + D)) | $66.67 | $33.33 |
| F | Unbiased Non-Price-Based Index Weight | $66.67 | $33.33 |
| | (E) | | |

By adjusting the size factor, (as illustrated in table 7, E and F above) provides for a technical solution to systematic bias inherent in existing non-price-based indexes.

In one or more embodiments, a determined non-price-based index weight may be determined based on one or more size factors and where a size factor may further be determined by an ex-post trailing average of one or more fundamental size factors. Further, a fundamental size factor (or a combination of one or more fundamental size factors) may be adjusted for volatility using the volatility-per-unit-growth rate.

It is appreciated herein that the steps performed in the various exemplary embodiments in this application should be characterized by the comprehension of the steps as intimately interconnected (holistic) and explicable only by reference to the whole. In other words, the utility of the invention explained by solutions to problems in the technical field is solved by the various exemplary embodiments and where the solutions can only be comprehended by utilizing all the steps, i.e., in an ordered combination of steps, to recite a practical application. It is furthermore understood that some embodiments are directed to particular solutions to particular problems and a particular way to achieve a desired outcome, in the technical field of non-price-based indexation, requires a securities indexing system (a special purpose computer as disclosed in various embodiments herein) which is a necessary requirement to achieve the desired outcome.

In this application, data objects (or object data) may refer to data received from a proprietary database, stored and structured in a multidimensional array. Data objects may further refer to accounting based fundamental data, financial ratios, bond market data, bond yields, Treasury yields, stock market data and the like. It is appreciated herein that a multidimensional array may comprise one or more arrays that are specifically configured to structure and store obtained and processed data. A multidimensional array may further be referred to as a spreadsheet or matrix in this application.

In some embodiments as described herein, the following describes some terms as used herein, and in some embodiments, such terms may have different meanings, such as the common meaning is understood in the art. It should be appreciated that some embodiments may use their common meaning unless recited to the contrary.

In this application (t0) represent present time; (t-n) is a point in time in the past; (tn) is a point in time in the future.

The term Universe of Stocks or Investment Universe refers to a group of securities in domestic or globally markets. An investment universe of stocks may include all listed stocks in the US or in global markets. An investment universe may also be an index, such as the S&P500, the Russell 1000, Russell 1000 Growth, Russell 1000 Value or Wilshire 5000 Total Market or MSCI World Index. It may further refer to the capitalization of stocks, such as large, mid or small cap-stock universes or investment styles, such as value, blend or growth stocks. An investment universe may also be referred to as an investable opportunity set.

The term price-based-index or price based index weight refers to price weighted index or price weighing of securities (e.g., Dow Jones Industrial Index) or market capitalization or market capitalization weight of a security or a group of securities (e.g., S&P 500). The term non-price-based index or non-price-based index weight refers to factors other than the market capitalization or market capitalization weight of a security or a group of securities. Non-price-based index weights are most commonly based on fundamental factors, but can also be based on other weighting methods, such as equal or score weighting.

In this application, the term tracking error may refer to how closely non-price-based index weights correlate (agree or match up) to standard price-based index weights or how closely a non-price-based index perform relative to a standard price-based index. Price-based index weights are generally based on market capitalization. It is appreciated that price-based index weights are based on human assessment, i.e., it represents investor's collective (i.e., the markets) option of individual securities value.

It is appreciated herein that in this application the term index, indexing, indexation and the like generally mean a plurality of securities that are weighted by the use of a securities index system, i.e., a special purpose computer system, that unitizes an automatic computerized, (and thus systematic, and/or rules-based) process.

The term data or data objects or data metrics and the like refer to various financial data that is used in the various exemplary embodiments in this application. In various exemplary embodiments financial data objects are obtained from one or more proprietary databases, which may be maintained by third party data providers. Financial data objects are updated in real time to ensure timeliness. Proprietary databases are constantly updated and accordingly updated data objects may be in real time received/obtained from one or more proprietary data bases. In order to compute unbiased non-price-based index weights, as disclosed in the various exemplary embodiments in this application, the system communicate with one or more proprietary databases, which provides the required data feeds. Data objects may in this application also be referred to as simply ‘data’.

The term “size factor” (or fundamental size factor) refers to accounting-based data found a company's income statement, balance sheet, cash flow statement and the like. A fundamental size factor may be a company's last reported revenues, earnings before interest and taxes, net earnings, cash flow, book value (shareholders equity), dividends, etc. Fundamental size factors may be reported quarterly, annually and/or on a trailing twelve months (TTM) basis. A composite of fundamental size factors may be computed as an equally weighted average of two or more fundamental size factors. In a preferred embodiment companies last reported trailing twelve months (TTM) net earnings is the fundamental size factor to be discounted. It is appreciated herein that size factors may be received/obtained from a third part proprietary database, e.g., Compustat, Thomson Reuters DataStream, Bloomberg, or FactSet. It is appreciated herein that such database providers operate in an oligopoly market and that access to proprietary database requires a subscription. It is further contemplated that systems and methods as disclosed in the various embodiments in this application receive and process data objects provided from one or more proprietary databases.

The term “growth rate” refers to a measure of ex-post growth in one or more size factors and/or related financial metrics over an ex-post period of time. The growth rate may be determined by calculating the growth rate based on a composite average of a multiple fundamental size factors; such as a company's (i) book value, (ii) revenues, and (iii) net earnings. An ex-post growth measurement may be based on a company's quarterly data or alternatively annual data which may be a based-on calendar year or fiscal year data. A sufficient ex-post period may be a three to six calendar years period. The growth rate may be based on four calendar years data and where trailing twelve-month (TTM) data, is used for the most recent period. Alternatively, the growth rate is based on an average profitability rate over an ex-post period of time. A profitability rate may be a company's return on equity (ROE), return on assets (ROA), return on invested capital (ROIC) or similar profitability factors. The growth rate may furthermore be based on a combination of fundamental size factors and profitability factors. The advantage of using one or more profitability factors in determining a growth rate is that it provides for an adjustment for profitability. It is appreciated herein that the risk-free rate constitutes the growth rate for a risk-free asset. A growth rate may be determined based on a compounded annual rate (CAGR), an average rate, a mean rate, a median rate or a mode rate. In a preferred embodiment the growth rate is determined as the composite average of two fundamental size factors (i) revenues, (ii) net earnings and one profitability factor (iii) return on assets (ROA) for an ex-post period of time.

The volatility-per-unit-growth rate is determined by calculating a deviation rate of the growth rate for a given stock for an ex-post period of time (t0-t-n), and then dividing the calculated deviation rate by the determined growth rate. The deviation rate may be calculated as the standard deviation or the semi deviation of the growth rate. It may be preferred to exclude the profitability factor when calculating the deviation rate. In a preferred embodiment, the deviation rate may be determined on a composite average measure of (i) revenues and (ii) net earnings. It is appreciated herein that if a company exhibits a high growth rate and a low deviation rate and thus a low volatility-per-unit-growth rate, leads to a low volatility premium and a low discount rate which, all else equal, leads to a high determined non-price-based index weight.

The volatility premium may be determined by multiplying the Volatility Per-Unit Growth rate with (by the) the Risk-Free Rate. Multiplying the Volatility Per-Unit Growth rate with (by the) the risk-free rate, establishes a coherent link between risky assets (e.g., stocks) and risk-free assets (e.g., Treasury notes). It is appreciated herein that risky assets may exhibit volatility (i.e., a deviation rate) while risk free assets by definition do not exhibit volatility, Hence, a risk-free asset exhibits a zero volatility per-unit growth rate and as a result the volatility premium for risk free assets is zero. It is further appreciated herein that the yield of a risk-free asset may represent the risk-free assets growth rate. Table 8 below illustrates the volatility per-unit growth rate and the volatility premium across two hypothetical stocks (risky assets) and one risk free asset.

TABLE 8
Illustrates the volatility premium across
two securities and the risk-free asset

| Factors/Variables | Security A | Security B | Risk Free Asset |
|---|---|---|---|
| Growth Rate (Yield) | 5.00% | 15.00% | 2.50% |
| Deviation Rate | 15.00% | 5.00% | 0.00% |
| Volatility-Per-Unit-Growth Rate | 3 | 0.33 | 0 |
| Risk Free Rate | 2.50% | 2.50% | 2.50% |
| Volatility Premium | 7.50% | 0.83% | 0.00% |

As illustrated in the table 8, the volatility premium is higher for securities that exhibit a higher volatility per-unit growth rate. Hence security A exhibits a higher volatility premium than stock B. The risk-free asset by definition exhibits zero volatility per-unit growth rate and volatility premium. It is appreciated herein that the volatility per-unit growth rate and the volatility premium provide for a coherent measure of volatility of the growth rate across the asset classes equity securities (stocks) and fixed income securities (bonds). It is appreciated herein that the volatility per unit growth rate may be expressed in either basis points, percentages or as a number (factor) as shown in table 8 above.

The volatility per-unit-growth rate may also in this application be referred to as the “unit-factor-volatility” or unit-factor-deviation rate or consistency rate. Volatility may also be referred to as a deviation rate. The various processes (methods), as disclosed in various embodiments herein, for providing a technical solution to systematic bias in prior art methods, may also in this application be referred to as a systematic bias control method.

The problem solved by various embodiments disclosed herein may be referred to a ‘systematic bias’. Systematic bias is inherent in existing technique's for determining non-price-based index weights due to their mere use of accounting based size factors which causes a systematic bias, or tilt bias towards securities that exhibit a low price relative to size factors. In this application the phrase or term ‘systematic bias’ may also be referred to as ‘systematic tilt bias’ or simply ‘tilt bias’. It is appreciated that the problem with existing techniques is that they tilt away from conventional market capitalization weighted indices (i.e., human techniques) which inherit the opposite tilt, i.e., a tilt towards securities that exhibit a high price relative to size factors. Therefore, the problem is that existing non-price-based index techniques do not provide for an unbiased alternative to conventional market capitalization weighted indices.

The discount rate is determined by adding the volatility premium to the risk-free rate. The discount rate (or discount factor) proxy both unsystematic (i.e., securities specific risk) and systematic risk (i.e., risk that affects all securities). It is appreciated herein that the risk-free-rate proxy systematic risk and the volatility premium unsystematic risk (company specific risk). The risk-free rate may further proxy inflation risk.

A profitability factor refers to a class of financial metrics that are used to assess a business's ability to generate earnings as compared to its assets, expenses and other relevant costs incurred during a specific period of time. Examples of profitability factors are return on assets (ROA), return on equity (ROE) and return on invested capital (ROIC) and the like. A profitability rate may refer to an average profitability rate of a company measured over an ex-post period of time. A profitability rate may furthermore be determined by a composite average of one or more profitability factors. The ex-post period of time over which an average is determined may correspond to the ex-post time period used to calculate the growth rate using one or more fundamental size factors. In a preferred embodiment a return on assets (ROA) is the profitability factor in determining a profitability rate.

The term “distributions” refer to dividends and stock repurchases paid and/or performed by a company over an ex-port period of time. Stock repurchases may also be referred to as “buybacks”. Distributions may be determined by adding (i) the most recent dividends paid by a company and (ii) the most recently performed stock buybacks by a company. In a preferred embodiment distributions are determined as (i) dividends plus (ii) buybacks as measured over a most recent trailing twelve months (TTM) period.

Book value refers to a company's shareholders equity which is commonly defined as the difference between total assets of a company and its total liabilities. It is appreciated herein that a book value is an accounting based fundamental size factor.

A Risk-Free Rate refers to the best competitive rate of return that does not involve taking a risk. Both the return of the original capital and the payment of interest are completely certain, i.e., carry no volatility. It is appreciated herein that a risk-free rate may be a theoretical rate. In determining a risk-free rate (it may be advantageous) to use a moving average of a risk-free rate over an ex-post period of time. The risk-free rate may be a return (yield or rate) derived from a risk-free asset. It is contemplated that the risk-free rate may vary depending on which country (or geographic zone) an embodiment is implemented. In a preferred US embodiment, the ten-year US Treasury note yield represents the risk-free rate.

A Risk-Free Asset may refer to fixed income securities. A risk-free asset may be a Treasury Security, such as treasury bills, treasury notes and bonds, inflation adjusted Treasury bonds (TIPS) but may further refer to a money market account or other asset that has a fixed return and the like. It is appreciated herein that Treasury Inflation-Protected Securities or TIPS provide protection against inflation. The principal of an inflation adjusted Treasury bonds increases with inflation and decreases with deflation, as measured by the Consumer Price Index. When an inflation adjusted Treasury bond matures, they are pay the adjusted principal or the original principal, whichever is greater.

In this application, an unbiased non-price-based index weight for a security may be determined as the higher of, 1) an earnings based non-price-based index weight, which is determined by discounting an earnings based fundamental size factor (e.g., net earnings) and 2) a book value, (a fundamental size factor). Further, as disclosed herein, both these non-price-based index weights my include distributions. It is understood that a fundamental size factor, such as net earnings, is received from company's income statement and the book value from a company's balance sheet. Fundamental size factors may also be referred to as a size factor. Size factors are obtained from one or more proprietary data bases, which may further be referred to data sources in this application.

The following is a useful tool that can be employed in various embodiments as disclosed herein. A Common Constituent Weight (CCW) refers to a fixed and one time index weight that are added for each security's determined non-price-based index weight in the universe of securities. A CCW may be added to a determined unbiased non-price-based index weight (which may further include distributions) (or other index weight) for each stock in an index of stocks for the purpose of reducing index weight concentration and thus by smoothening (or rescale) the index weights of an index. The advantage of a CCW is that it reduces index weight concentration in an index. A CCW is a constant value and can be of any size. The greater (or higher) the CCW is, the higher the smoothing and the lower the concentration of index weights in an index. To illustrate, consider an index comprising three stocks with the following determined non-price-based index weights, stock A $100, stock B $50, and stock C $10. The total index weight for the stocks is consequently $160. Such an index would be highly concentrated in Stock A. In order to reduce this concentration a CCW of $100 may be added to each stocks determined non-price-based index weight. Table 9 below illustrates a Common Constituent Weighting (CCW) across three hypothetical stocks.

TABLE 9
Common Constituent Weighting (CCW) of $100

| | Unbiased | | | | |
|---|---|---|---|---|---|
| | Non-Price- | | | | |
| | Based Index | Index | | Adjustment | Adj. Index |
| | Weight (A) | Weight % | CCW | (A + CCW) | Weight % |
| Stock A | $100 | 62.50% | $100 | $200 | 43.50% |
| Stock B | $50 | 31.30% | $100 | $150 | 32.60% |
| Stock C | $10 | 6.30% | $100 | $110 | 23.90% |
| Total | $160 | 100.00% | $300 | $460 | 100.00% |

As illustrated in table 9, the CCW reduces the concentration risk by lowering the relative weight for stock A and increasing the relative weights for stock B and C. It is appreciated herein that a CCW adjusted index weights improves over equal weighting (i.e., an equal weighted index) by allowing smoothen index weights while still providing an exposure to growth stocks, i.e., exposure to strong performance factors. This is achieved by keeping the CCW weight constant over time, i.e., not making any changes to the CCW. This provides for cost benefits as compared to the conventional equal weighted indexes which rebalances frequently to maintain equal weights for all securities comprising the index, which in turn leads to high implementation costs (i.e., high turnover costs). It is understood by the skilled in the art that an equal weighted index systematically tilts towards value stocks, i.e., stocks that exhibit a low price relative to size factors) and thus inherit a systematic bias relative to standard market price weighted indices. It is appreciated that the CCW tool, as discussed above, provide for a novel and a new useful tool that provides for a solution to systematic bias inherent in equal weighed indexes.

Another advantage of CCW adjusted index weights is that they do not require frequent rebalancing. A CCW portfolio may be rebalanced once every two, three years, or five years or even once every ten years. It is appreciated herein that a CCW adjusted index weights benefits investors by allowing for a significantly lower implementation costs, i.e., lower transactions costs related to rebalancing the index, as compared to conventional equal weighted indexes, which requires frequent rebalancing to maintain an equal weight and for that reason exhibits high implementation costs.

TABLE 10
Common Constituent Weighting (CCW) of $1000

| | Non-Price | | | Adj. Index | |
|---|---|---|---|---|---|
| | Based Index | Index | | Weight | Adj. Index |
| | Weight | Weight % | CCW | (FV + CCW) | Weight % |
| Stock A | $100 | 62.50% | $1,000 | $1,100 | 34.81% |
| Stock B | $50 | 31.25% | $1,000 | $1,050 | 33.23% |
| Stock C | $10 | 6.25% | $1,000 | $1,010 | 31.96% |
| Total | $160 | 100.00% | $3,000 | $3,160 | 100.00% |

Table 10 above illustrates a Common Constituent Weighting (CCW) of $1000 across the same three hypothetical stocks.

As illustrated, a higher CCW (now $1000 as opposed to $100) further reduces index weight concertation in an index. Such CCW adjusted index may only be rebalanced every firth or tenth year which provides for improved implementation costs over conventional and existing methods. It is further contemplated that a common constituent weight (CCW) may not only be added to a determined non-price-based index weight as illustrated in table above, but may also be added to fundamental size factors or price-based indexes, and the like.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer.

It is appreciated herein that the steps performed in the various exemplary embodiments in this application should be characterized by the comprehension of the steps as intimately interconnected (holistic) and explicable only by reference to the whole. In other words, the utility of the invention explained by solutions to problems in the technical field is solved by the various exemplary embodiments and where the solutions can only be comprehended by utilizing all the steps, i.e., in an ordered combination of steps, to recite a practical application. It is furthermore understood that some embodiments are directed to particular solutions to particular problems and a particular way to achieve a desired outcome in the field of non-price-based indexation of securities and that the exemplary embodiments requires a securities indexing system (a special purpose computer) which is a necessary requirement to achieve the desired outcome.

Although the invention has been described with reference to a particular arrangement of parts, features and the like, these are not intended to exhaust all possible arrangements or features, and indeed many other modifications and variations will be ascertainable to those of skill in the art.

It is understood that non-price-based securities indexing systems and thus the various embodiments disclosed herein require one or more proprietary data bases (data sources) that are connected to the indexing system, as disclosed herein, to allow the system to perform the disclosed embodiments. Hence, it is understood that the methods and techniques as disclosed herein cannot be performed (merely) on a general-purpose computer but rather requires a special purpose computer. Hence, it is clear that in some embodiments, the disclosed methods and techniques, for providing for a solution to systematic bias in existing methods and systems (as a whole), obtain data from one or more proprietary databases (data sources) which are a necessary part of a non-price-based securities indexation system.

It is appreciated that one or more embodiments herein unitizes a multidimensional array to structure and store financial objects obtained from one or more third party proprietary databases, and retrieval system and a computer memory, and means for configuring said memory according to a logical table, said logical table including: a plurality of logical rows, each said logical row including an object identification number (OID) to identify each said logical row, each said logical row corresponding to a record of information comprising a financial object, a plurality of logical columns intersecting said plurality of logical rows to define a plurality of logical cells, each said logical column including an OID to identify each said logical column providing the means for efficiently structuring and storing obtained object data and partly and fully processes data in a particular structure which more efficiently facilitates the processing of the process (methods), as disclosed in various embodiments herein, and as illustrated in FIG. 6, and FIG. 6A-D.

It is appreciated that the multidimensional array and the specifically configured memory aid the method to perform more efficiently, and thus more accurately achieve the desired result. The multidimensional array and the specifically configured memory automatically structure and store obtained data from one or more third party proprietary databases. The multidimensional array furthermore structures and stores the process steps of the various embodiments as discoursed herein. Accordingly, the multidimensional array and the specifically configured memory allows the various processes (as disclosed herein) to more efficiently access data without having to continuously utilizing one or more processors to obtain data from external data sources. The multidimensional array automatically structure and store obtained data in a logical structure in a specific way to facilitate the process of determining unbiased non-price-based index weights for a plurality of securities. The multidimensional array furthermore stores the claimed process steps which allow the various embodiments, as disclosed herein, to access and process data more efficiently. That in turn improves accuracy, reduces processing times, and memory (RAM) requirements.

It is appreciated herein that the internal database, which comprises of one or more multidimensional arrays, and by the use of one or more processor's structures and stores the obtained data from one or more external databases in a particular way to facilitate a more efficient processing of the claimed method steps. This in turn lead to reduced processing requirements and (RAM) memory usage which improves the overall securities indexation system. It is furthermore appreciated herein that the internal database and the particular structure of data stored in one or more multidimensional arrays allow for an increased speed of accessing data, which include functions of applications that is included in the electronic devices, as such the internal database architecture operating in a new or unconventional fashion.

It is appreciated herein that the various embodiments, as disclosed herein, obtains data from one or more proprietary databases in the specific process of computing unbiased non-price-based index weights in non-price-based indexation. Hence, it is appreciated that the various embodiments herein, requires a particular machine (a special purpose computer) that is configured using specialized hardware and proprietary software necessary to permit the claimed processes (methods) to be performed.

It is appreciated herein that the technical field, non price based indexation of securities, is an existing technology, which rely on particular machines to obtain data and carry out various desired processes. Hence, desired processes in the technical field cannot be practically performed without the use of particular machines (particular computer system).

The embodiments, as disclosed herein, provides a new process (method) that specifically provides for a technical solution to a problem (systematic bias) inherent existing non-price-based index processes and further provide for an improved non-price-based indexation system by providing for new logical structures embodied in one or more multidimensional arrays' which provides for improved computer functionality in the technical field (non-price-based indexation of securities). Again, it is appreciated that the technical field (non-price-based indexation of securities) is an existing technology, i.e., an existing technological process which requires special purpose technology.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

It is appreciated herein that various embodiments of the invention may be implemented as one or more methods, of which an example has been provided herein. The acts performed as part of the various method(s), as disclosed herein, may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

Some objects consistent with at least some aspects, as disclosed herein, is to improve over existing non-price-based index systems and methods by providing for specific solutions to problems in conventional industry practices. Among its several aspects, the present embodiments provide new methods/techniques for computers and software that enables to improve existing technological processes in the technical field.

These and other aspects of the invention are expanded upon throughout the specification. Aspects of the present invention address deficiencies in existing methods and systems by providing advantageous alternatives thereto so that new computer-based processes, approaches, methods, tools and techniques are provided of various aspects as defined by the claims.

Some embodiments are being directed towards new and useful methods, by which computer technology can detect and provide for a solution to systematics bias inherent in conventional and existing system and methods. The same embodiments further improve non-price-based indexation by allowing for a method that provides for a technical solution for systematic bias inherent in existing non-price-based system and methods. Hence, these embodiments are directed to new methods for determining unbiased non-price-based index weights for individual securities in non-price-based indexation of securities. It is appreciated that some embodiments, as disclosed herein, provides for a specific technical solution to technical problems inherent in existing non-price-based index methods and thus are directed to a new and useful end.

Embodiments, as disclosed herein, improve computing unbiased non-price-based index weights by providing for specific technical solutions to problems in existing non-price-based systems and methods for indexation of securities. It is further understood that the specific processes, methods, techniques, as are disclosed herein, requires a special purpose computer (a non-price-based securities indexation system) and thus cannot be practically performed by humans, with or without prior art errors. The various embodiments, as disclosed herein, provides for specific methods that improves over existing non-price-based index methods and thus provides for an improvement in an existing technological process.

It is further appreciated that the embodiments, as disclosed herein, improves existing technology, i.e., non-price-based indexation, and that the various embodiments are directed to a specific process that performs functions not previously performable by computers, i.e., provides for a technical solution to a problem (systematic bias) in determining non-price index weights in non-price-based indexation of securities. Hence, the various embodiments, as disclosed herein, are directed to specific technical solutions to technical problems (biases) in an existing technology and these new functions are thus not generic computer functions.

Some embodiments, as disclosed herein, further improve existing securities indexing systems and methods by providing for particular solutions to problems as discussed in this application. Some aspects of the present invention improve conventional industry practices (i.e., existing technology) by providing for new processes, methods and techniques for computing unbiased non-price-based index weights. It is appreciated herein that the processes, methods and techniques as disclosed herein are integral with computer technology. Hence, it is clear from the specification that the various embodiments, as disclosed herein, depends on computer technology to provide the desired result. It is further appreciated that the computer/apparatus is integral to the claimed method to sufficiently aid the method to achieve the desired result and thus provides for a practical application (i.e., the new and useful result). It is furthermore appreciated that the improvements over existing systems, results in an improved process, method, techniques which further provides for an new and useful database structure and user interface for electronic devices, e.g., structuring of obtained and processed data objects and transformation of obtained object data into a particular visual depiction of a physical object on a display.

It is appreciated that some embodiments are directed to particular elements for improving the processing of the method steps of the present invention, these elements include particular memory configuration and storage system allowing obtained and processed data to be increasingly accessible for further processing, which in turn reduces processing times and memory usage. It is appreciated that these aspects of the present invention improve the functioning of electronic devices.

Some embodiments of the present invention are directed to improvement in existing technology (non-price based indexation of securities) by providing new functionality and capabilities that provides for specific solutions to problems and thus provides for an improvement in the functioning of a computer by providing for new improved technological processes. It is appreciated herein that the various embodiments, as disclosed herein, is directed to improvement in existing technology, computer-related technology, by allowing computer perform functions not previously performable by a computer.

It is appreciated that the present invention, as disclosed in various embodiments herein, recites specific steps (method or process) to accomplish a desired result, and not only a result. Hence, the present invention improves particular computer technology, non-price based indexation of securities. It is appreciated the present invention is directed to a specific method of providing for a technical solution to a technical problem in a specific technology (non-price-based indexation) to achieve a specific outcome. Accordingly, embodiments of the present invention addresses a specific technical problem in a specific technical field, not a longstanding business practice, by providing for a specific technical solution to a technical problem, and thus a new and useful end result.

It is appreciated that a securities indexing system is a machine. It is further appreciated that a machine may further comprise an apparatus, designed for a particular purpose. It is further appreciated that a computer is a machine and that an apparatus may be a part of improving a machine for a specific purpose. In the present embodiments, as disclosed herein, an apparatus is being constructed to support the methods (processes) as disclosed in various embodiments herein. It is appreciated that the internal database and the multidimensional array is an apparatus, particularly designed to more efficiently facilitate the processes (methods) as disclosed in various embodiments herein. It is further appreciated herein that the term “system” may refer to a machine, which may further comprise an apparatus.

Further, it is appreciated herein that one or more embodiments, as disclosed herein, are directed to a special purpose computer (a particular machine) which is designed and configured using specialized hardware, and proprietary software, which are necessary components to permit the claimed processes methods and techniques, as disclosed herein, to be performed. It is appreciated that the securities indexing system is necessary in permitting the claimed processes, methods, and techniques to be performed. It is appreciated that the apparatus, comprising a specifically configured internal database and multidimentional array, as described herein, is integral to the securities indexing system, i.e., to the machine.

It is understood that the embodiments, as disclosed herein, are directed to specific solutions to problems in conventional industry practices and thus the claims and embodiments provides for an improvement to existing technology, such as improving computing non-price-based index weights in such manner that it allows to achieve one of several expressly desired objectives as described herein. It is further appreciated that the various embodiments recite specific techniques, methods and processes, elements or process steps, and when considered in an ordered combination, are not well understood, routine and conventional activities in the technical field. It is appreciated that the various embodiments provide a clear and distinct improvement to existing processes in the technical field. It is appreciated that the embodiments and its limitations as a whole recite an inventive concept and thus more than the performance of well-understood, routine, and conventional activities previously known in the industry. It is appreciated that the claimed system and process have the specificity required to transform a claim from one claiming only a result to one claiming a way of achieving it. It is appreciated that the present invention, as disclosed in various embodiments herein, enhances non-price-based indexation by providing for an improved process over existing processes (methods) and by providing for desired goals and benefits as described in this application. It is appreciated that the combination of elements, i.e., the claimed process or method, as a whole, that operates in an unconventional manner to achieve an improvement in existing technology, i.e., a new and useful end. Its appreciated that the system, apparatus and methods, as described herein, comprise elements that transform an article to a different state of thing.

It is furthermore appreciated that the machine and apparatus, specifically configured for computing unbiased non-price-based weights in non-price-based indexation of securities (the technical field), provides for improved computer technology by providing new functionality and capabilities. It is appreciated that the embodiments, as disclosed herein, provides for specific technical solutions to technical problem and thus provides for an new and improved technological process. It is appreciated that the various embodiments, as disclosed herein, focus is on providing for a specific solution to a specific problem (systematic bias) in an existing technology (non-price-based indexation of securities). It is further appreciated that the new functions, as provided by the embodiments, as disclosed herein, have not previously been performable by computers. Accordingly, the embodiments, as disclosed herein, are directed to specific technical solutions to a technical problem and that the solution explains how to achieve specific end result, and not merely a result. It is appreciated that the new computer functions, as disclosed in the embodiments herein, are not generic computer functions.

It is appreciated that the apparatus, as disclosed herein, comprising a specifically configured internal database and a multidimensional array, provides for additional improvements, by allowing the embodiments, as disclosed herein, perform more efficiently, by reducing processing errors, reducing processing times and memory requirements. It is appreciated that the securities indexing system, as disclosed herein, is a particular machine, designed for its particular purpose. It is appreciated that the technical solution, as described herein, to the problem being addressed is necessarily rooted in computer technology in order to overcome a problem specifically arising in an existing computer technology, i.e., automated non-price-based indexation of securities. It is appreciated that the specifically configured apparatus, as described herein, and processing system operate different from existing systems in the technical field. It is appreciated that the apparatus, as described herein, provides for improved computer functionality.

It is appreciated that the new and novel mathematical calculations, which are part of the present invention, are technical in nature, i.e., mathematics is a technical discipline. It is further appreciated that the present methods, as disclosed in various embodiments herein, uses calculations as part of providing for a technical solution to a technical problem in prior art. It is furthermore appreciated that these calculations relate to applied mathematics (i.e., for the precise description of the operations), and not pure mathematics or a mathematical formula of law of nature.

It is further appreciated that the embodiments, as described herein, do not seek protection for the mathematical calculations, but instead for a process (method), as described herein, that provide for technical solution to a technical problem (systematic bias) in the technical field. Accordingly, the embodiments, as described herein, are not directed to a mathematical concept, formula, or calculations, but instead the embodiments, as described herein, are directed to a technological process for providing a particular technical solution to a technical problem in the technical field. It is appreciated that the embodiments, as described herein, is not directed to a mathematical concept, but rather use a mathematical concept as part of providing a solution to the problem. It is further appreciated that the mathematical calculations used as part of providing for a solution to the problem does not preempt others from using mathematical calculations.

It should be noted that, while various functions, systems and methods have been described and presented in a sequence of steps, the sequence has been provided merely as an illustration of advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to unitize all or any portion of the functions described herein. While embodiments of the present invention, have been described herein for purposes of illustration, modifications and changes will become apparent to those skilled in the art. Accordingly, the appended claims are not intended to encompass all such modifications and changes as fall within the true spirit and scope of this invention. While various embodiments of the present invention have been described in this application, it should be understood that they have been presented by way of example only, and not limitation. Thus, the breadth and scope of the present invention should not be limited by any of the above-described exemplary embodiments, but should instead be defined in accordance with the following claims and their equivalents. Further, while this invention has been particularly shown and described with references to example embodiments thereof, it will be understood by those skilled in the art that various changes in form and details may be made therein without departing from the scope of at least one embodiment encompassed by the appended claims.

What is claimed is:

1. A machine and apparatus specifically configured for computing unbiased non-price-based index weights, said system comprising: a computer connected to a communication network, said computer obtains through one or more proprietary databases connected to the network real-time data objects associated with a universe of securities, the computer structuring and storing obtained data objects in specifically configured internal database, a storage medium connected to said computer and having a program stored thereon, the program executed by the computer in real time computing unbiased non-price-based index weights for each given security in the universe of securities, for each given security automatically:
a. obtaining size factor object data from one or more proprietary databases, for each given security at present time (t0), the data objects being obtained from the multidimensional array in the storage medium;
b. providing for a solution to systematic bias by determining an adjusted size factor at present time (t0), for each given security, the computer stores the adjusted size factor in the multidimensional array in the storage medium;
c. generating an unbiased non-price-based index weight for the given security at present time (t0), the unbiased non-price-based index weight, for the given security, being structured and stored in the multidimensional array in the storage medium; the computer system according to the program automatically performs steps a. through c. for each given security, transforming obtained data objects to an unbiased non-price-based index weight, for each given security, and wherein the computer system automatically in real-time updates the unbiased non-price-based index weight, for each given security, and stores the updated unbiased non-price-based index weight in the multidimensional array.

2. The machine and apparatus according to claim 1, wherein the computer network further comprises a graphical user interface (GUI) configured to display unbiased non-price-based index weights as structured and stored in the multidimensional array in the storage medium.

3. The machine and apparatus according to claim 1, wherein the operations further comprise instructions to adjust the generated unbiased non-price-based index weight for each given security, in the universe of securities, by applying a non-price-based common constituent weight.
